(19) United States
(12) Patent Application Publication
(10) Pub. No.: US 2025/0227791 A1
(43) Pub. Date: Jul. 10, 2025

(54) DEVICE CONNECTION METHOD AND BLUETOOTH DEVICE

(71) Applicant: GUANGDONG OPPO MOBILE TELECOMMUNICATIONS CORP., LTD., Dongguan (CN)

(72) Inventor: Yuan TIAN, Dongguan (CN)

(73) Assignee: GUANGDONG OPPO MOBILE TELECOMMUNICATIONS CORP., LTD., Dongguan (CN)

(21) Appl. No.: 19/092,643

(22) Filed: Mar. 27, 2025

Related U.S. Application Data
(63) Continuation of application No. PCT/CN2023/108294, filed on Jul. 20, 2023.

(30) Foreign Application Priority Data
Sep. 30, 2022 (CN) 202211230955.7

(51) Int. Cl. H04W 76/15; H04W 4/80; H04W 76/14

(52) U.S. Cl. CPC H04W 76/15; H04W 4/80; H04W 76/14

(57) ABSTRACT

A device connection method, a device connection apparatus, and a Bluetooth device are provided, and the device connection method includes: receiving a Bluetooth low energy (BLE) connection request sent by a third Bluetooth device in a case where a classic Bluetooth connection is established between the first Bluetooth device and a second Bluetooth device; responding to the BLE connection request and establishing a BLE connection with the third Bluetooth device in a case where the second Bluetooth device and the third Bluetooth device are the same device; and rejecting the BLE connection request in a case where the second Bluetooth device and the third Bluetooth device are different devices.

### CROSS REFERENCE TO RELATED APPLICATIONS

This application is a continuation of International Patent Application No. PCT/CN2023/108294, filed Jul. 20, 2023, which claims priority to the Chinese Patent Application No. 202211230955.7, filed Sep. 30, 2022, both of which are herein incorporated by reference in their entireties.

### TECHNICAL FIELD

Some embodiments of the present disclosure relate to the field of communication technologies, in particular to a device connection method and a Bluetooth device.

### BACKGROUND

Wireless Bluetooth earphones widely use classic Bluetooth audio technology for data transmission. With the development of the Bluetooth technology, the wireless Bluetooth earphones are gradually adopting Bluetooth Low Energy (BLE) audio technology based on the BLE standard protocol for data transmission. Although both the classic Bluetooth technology and the BLE technology are called the Bluetooth technology, the classic Bluetooth technology and the BLE technology have many different characteristics and are not compatible with each other. Therefore, the classic Bluetooth technology and the BLE technology may be essentially considered as two different short-range communication technologies.

Currently, to improve device compatibility, wireless Bluetooth earphones may be designed to support both the classic Bluetooth audio technology and the BLE audio technology. Such wireless Bluetooth earphones are called dual-mode Bluetooth earphones. The dual-mode Bluetooth earphones may establish both a classic Bluetooth connection and a BLE connection with a terminal device. However, there is an uncertainty in how the dual-mode Bluetooth earphones establish both the classic Bluetooth connection and the BLE connection with the same terminal device.

### SUMMARY

Some embodiments of the present disclosure provide a device connection method performed by a first Bluetooth device. The method includes: receiving a Bluetooth low energy (BLE) connection request sent by a third Bluetooth device in a case where a classic Bluetooth connection is established between the first Bluetooth device and a second Bluetooth device; responding to the BLE connection request and establishing a BLE connection with the third Bluetooth device in a case where the second Bluetooth device and the third Bluetooth device are the same device; and rejecting the BLE connection request in a case where the second Bluetooth device and the third Bluetooth device are different devices.

Some embodiments of the present disclosure provide a device connection method performed by a third Bluetooth device. The method includes: sending a Bluetooth low energy (BLE) connection request to a first Bluetooth device in a case where a classic Bluetooth connection is established between the third Bluetooth device and the first Bluetooth device; and establishing a BLE connection with the first Bluetooth device.

Some embodiments of the present disclosure provide a Bluetooth device including a memory and a processor. The memory stores a computer program that, when executed by the processor, enables the processor to implement any one of the above methods.

### BRIEF DESCRIPTION OF THE DRAWINGS

FIG. 1 is a schematic diagram illustrating a connection relationship of a Bluetooth communication system.

FIG. 2 is a schematic diagram illustrating a connection relationship of a Bluetooth communication system.

FIG. 3 is a flowchart of a device connection method according to some embodiments of the present disclosure.

FIG. 4 is a flowchart of a device connection method according to some embodiments of the present disclosure.

FIG. 5 is a schematic diagram of illustrating connection relationship of a Bluetooth communication system.

FIG. 6 is a flowchart of a device connection method according to some embodiments of the present disclosure.

FIG. 7 is a flowchart of a device connection method according to some embodiments of the present disclosure.

FIG. 8 is a flowchart of a device connection method according to some embodiments of the present disclosure.

FIG. 9 is a structural block diagram of a connection apparatus according to some embodiments of the present disclosure.

FIG. 10 is a structural block diagram of a connection apparatus according to some embodiments of the present disclosure.

FIG. 11 is a structural block diagram of a Bluetooth device according to some embodiments of the present disclosure.

### DETAILED DESCRIPTIONS

The technical solutions in embodiments of the present disclosure are clearly and completely described in conjunction with the drawings in the embodiments of the present disclosure. It is obvious that the described embodiments are only some embodiments of the present disclosure, and not all embodiments. All other embodiments acquired by those skilled in the art based on the embodiments in the present disclosure without the creative work are all within the scope of the present disclosure.

It should be noted that the terms “include” and “have”, and any variations thereof used in some embodiments and accompanying drawings of the present disclosure are intended to cover un-exclusive inclusion. For example, a process, a method, a system, a product, or a device that includes a series of operations or units is not limited to the listed operations or units, but may optionally also include operations or units not listed, or may optionally include other operations or units inherent to the process, the method, the product, or the device.

It should be understood that the terms “first”, or “second”, etc., used in some embodiments of the present disclosure may be used to describe various elements, but these elements are not limited by these terms. These terms are only used to distinguish one element from another. For example, without departing from the scope of the present disclosure, a first earphone may be called a second earphone, and similarly, a second earphone may be called a first earphone. Both the first earphone and the second earphone are earphones, but they are not the same earphone. The term “multiple” used in some embodiments of the present disclosure refers to two or more. The term “and/or” used in some embodiments of the present disclosure refers to one of solutions or any combination of multiple solutions.

A wireless earphone, unlike a traditional wired earphone that use cables for data transmission, use a Bluetooth technology for wireless data transmission. Therefore, the wireless earphone is also called a wireless Bluetooth earphone. The wireless Bluetooth earphone includes the most common True Wireless Stereo (TWS) earphone. The wireless Bluetooth earphone is just one type of Bluetooth audio playback device that uses the Bluetooth technology for audio playback. Other Bluetooth audio playback device using the same technology includes a Bluetooth speaker, a wireless hearing aid, or a smart wearable device (used as an audio playback device), etc., which are not repeated here. Correspondingly, an audio source device for the Bluetooth audio playback device may include a smart handheld device, a smart tablet device, a laptop terminal device, a desktop terminal device, or a smart wearable device (used as an audio source device), etc., which are not repeated here. The audio source device refers to a device that sends audio data, and the audio playback device refers to a device that receives the audio data and outputs a sound signal.

The Bluetooth (BT) technology has evolved to the fifth generation after years of research. Based on the differences in underlying technologies, Bluetooth 1.0, Bluetooth 2.0, Bluetooth 3.0,and their derivative standard versions may be called a classical Bluetooth, while Bluetooth 4.0,Bluetooth 5.0, and their derivative standard versions may be called Bluetooth low energy (BLE). The classical Bluetooth and the BLE have different underlying technologies. Thus, the classical Bluetooth and the BLE are incompatible with each other, and are essentially two different short-range communication technologies. Both the Classical Bluetooth and the BLE may support an audio application. A protocol related to an audio application in the Classical Bluetooth is called a classic Bluetooth audio, and a protocol related to an audio application in the BLE is called a Bluetooth Low Energy (BLE) audio or a low energy audio (LEA).

In the related art, the Bluetooth classic audio has the characteristics of high power consumption, large data transmission volume, and small transmission range, making it suitable for high-quality audio scenarios, such as playing a lossless music. The BLE audio has the characteristics of low power consumption, small data transmission volume, and large transmission range, making it suitable for low-latency scenarios, such as playing a game audio. Additionally, since a BLE audio (such as the Bluetooth 5.2) standard protocol has not yet been widely used and the technology is not yet mature, the BLE audio cannot completely replace the Bluetooth classic audio. In this situation, to fully utilize the advantages of the two Bluetooth technologies and improve the device compatibility, an audio playback device designed to support both the Bluetooth classic audio and the BLE audio has become an option. An audio playback device developed based on this concept may be called a dual-mode (supporting both the Bluetooth classic audio mode and the BLE audio mode) Bluetooth device. Correspondingly, a device that supports only one Bluetooth audio technology (supporting the Bluetooth classic audio or the BLE audio) may be called a single-mode Bluetooth device. For an audio source device, the same situation exists, so that an audio source device that supports both the Bluetooth classic audio and the BLE audio may also be called a dual-mode Bluetooth device.

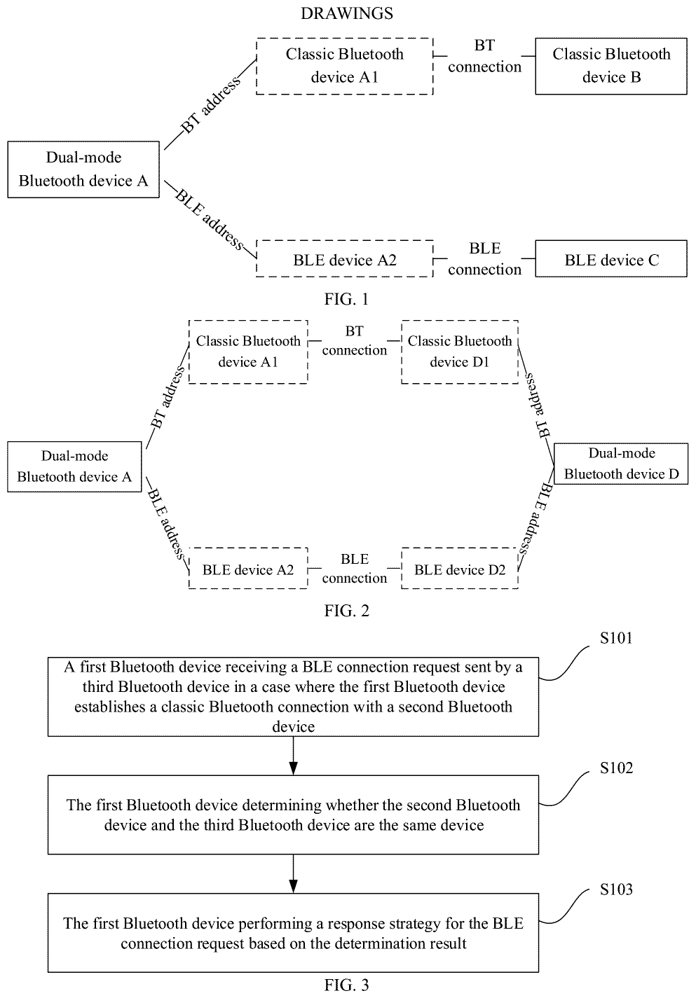

The dual-mode Bluetooth device has a classic Bluetooth (BT) address and a BLE address. The BT address refers to a Bluetooth MAC address, and is configured to identify the identity of a Bluetooth device. The BT address may be either fixed or variable, which is not limited here. As shown in FIG. 1, since a dual-mode Bluetooth device A has both the BT address and the BLE address, and the BT address and the BLE address are different from each other, the dual-mode Bluetooth device A is generally identified as two Bluetooth devices, namely a classic BT device A1 and a BLE device A2. If these two Bluetooth devices are not bound together, it is possible for the dual-mode Bluetooth device A to be connected to a classic Bluetooth device B when the dual-mode Bluetooth device A acts as the classic Bluetooth device A1, and connected to a BLE device C when the dual-mode Bluetooth device A acts as the BLE device A2, leading to an uncertainty of connection. Taking a dual-mode Bluetooth earphone as an example, this uncertainty of connection may be reflected in the following situation: in a case where the dual-mode Bluetooth earphone have been paired with multiple terminal devices, when the dual-mode Bluetooth earphone is started, both a classic Bluetooth interface and a BLE interface enter a connectable state; since device information of the dual-mode Bluetooth earphone has been recorded by the multiple terminal devices, when the multiple terminal devices are within a communication range of the dual-mode Bluetooth earphone, the dual-mode Bluetooth earphone may establish a classic Bluetooth connection with one terminal device and establish a BLE connection with another terminal device. The connection result depends on a speed and an order of connection initiation between the multiple terminal devices and the dual-mode Bluetooth earphone, and this kind of speed and order are random. The randomness of the speed and order leads to the uncertainty of connection between the dual-mode Bluetooth earphone and the multiple terminal devices.

Moreover, a dual-mode Bluetooth device as an audio playback device may only perform one audio service at a time. In case that the classic Bluetooth device and the BLE device connected to the dual-mode Bluetooth device are not the same device (i.e., the classic Bluetooth device and the BLE device connected to the dual-mode Bluetooth device are different devices), there will be a competitive relationship between them in using the dual-mode Bluetooth device for audio playback, and this competition is unscheduled. The unscheduled competitive relationship will lead to internal communication chaos and insufficient stability in a Bluetooth system of the dual-mode Bluetooth device. Therefore, the user expects that the classic Bluetooth device and the BLE device connected to the dual-mode Bluetooth device are represented by another dual-mode Bluetooth device. Obviously, the scenario shown in FIG. 1, where the dual-mode Bluetooth device A is connected to different Bluetooth devices B and C, does not meet the user expectation. As shown FIG. 2, a normal usage scenario is that the dual-mode Bluetooth device A acting as a classic Bluetooth device A1 establishes a classic Bluetooth connection with a dual-mode Bluetooth device D acting as a classic Bluetooth device D1, while the dual-mode Bluetooth device A acting as a BLE device A2 establishes a BLE connection with the dual-mode Bluetooth device D acting as a BLE device D2. In such a Bluetooth system, the dual-mode Bluetooth device A and the dual-mode Bluetooth device D may choose to use either the classic Bluetooth connection or the BLE connection for data transmission, fully utilizing the technical advantages of both the classic Bluetooth and the BLE.

It should be noted that the above establishment of a Bluetooth connection may be understood to include establishment of a physical link, such as an asynchronous connectionless (ACL) and/or a synchronous connection-oriented (SCO), etc., or establishment of a transmission link for connection of upper-layer protocols, such as an advanced audio distribution profile (A2DP), a hands-free profile (HFP), a connected isochronous stream (CIS), or a broadcast isochronous stream (BIS), etc.

To establish the connection relationship of the Bluetooth system shown in FIG. 2, a connection creation mechanism is required to be designed to ensure that a dual-mode Bluetooth device only establishes both a classic Bluetooth connection and a BLE connection with another dual-mode Bluetooth device and reduce an uncertainty of connection of dual-mode Bluetooth devices.

Some embodiments of the present disclosure provide a device connection method, a device connection apparatus, a Bluetooth device, and a storage medium, which may clarify the mechanism for a dual-mode Bluetooth device to establish connection with other devices, ensuring that a dual-mode Bluetooth device only establishes both a classic Bluetooth connection and a BLE connection with another dual-mode Bluetooth device, improving the certainty and stability of connection of the dual-mode Bluetooth devices.

As shown in FIG. 3, in some embodiments, a device connection method is provided. The device connection method is applied to or performed by a first Bluetooth device. In some embodiments, the method may include the following operations.

An operation S101 includes: a first Bluetooth device receiving a BLE connection request sent by a third Bluetooth device in a case where the first Bluetooth device establishes a classic Bluetooth connection with a second Bluetooth device.

An operation S102 includes: the first Bluetooth device determining whether the second Bluetooth device and the third Bluetooth device are the same device.

The same device refers to the same one device. Therefore, the first Bluetooth device determines whether the third Bluetooth device is the second Bluetooth device or another Bluetooth device other than the second Bluetooth device.

An operation S103 includes: the first Bluetooth device performing a response strategy for the BLE connection request based on the determination result.

As described in the operation S101, the first Bluetooth device receives the BLE connection request sent by the third Bluetooth device in a case where the first Bluetooth device establishes the classic Bluetooth connection with the second Bluetooth device.

In some embodiments, both the first Bluetooth device and the second Bluetooth device are dual-mode Bluetooth devices.

For two dual-mode Bluetooth devices (taking the first Bluetooth device and the second Bluetooth device as an example), an initial pairing refers to the initial or first connection between the first Bluetooth device and the second Bluetooth device in a case where no classic Bluetooth connection or BLE connection has been ever established between the first Bluetooth device and the second Bluetooth device. After the initial pairing is performed, both the first Bluetooth device and the second Bluetooth device may record each other's device information (such as identity information). Reconnection refers to a case where the first Bluetooth device and the second Bluetooth device connect again after the first Bluetooth device and the second Bluetooth device have established and disconnected the Classic Bluetooth connection and the BLE connection. Before reconnection, both the first Bluetooth device and the second Bluetooth device have already recorded each other's device information. This embodiment is applicable to the initial pairing or the reconnection.

The first Bluetooth device may first establish a classic Bluetooth connection with the second Bluetooth device. A classic Bluetooth interface of one of the first Bluetooth device and the second Bluetooth device is configured in a connectable state, and the other of the first Bluetooth device and the second Bluetooth device may scan and initiate establishment of a connection to establish the classic Bluetooth connection between the first Bluetooth device and the second Bluetooth device.

After establishing the classic Bluetooth connection is established between the first Bluetooth device and the second Bluetooth device, the first Bluetooth device and the second Bluetooth device may further then establish a BLE connection therebetween. In some embodiments, the second Bluetooth device may initiate the establishment of the BLE connection. In other embodiments, the first Bluetooth device may initiate the establishment of the BLE connection.

Taking the second Bluetooth device initiating the establishment of the BLE connection as an example, the first Bluetooth device, while performing BLE broadcasting, receives a BLE connection request sent by the third Bluetooth device (which may be the second Bluetooth device). The BLE broadcast is a message broadcasted by the first Bluetooth device in a case where the first Bluetooth device acts as a peripheral device, and the BLE broadcast is configured to indicate a central device which scans and finds the BLE broadcast that, the first Bluetooth device is capable of responding to a BLE connection request sent by the central device. Responding herein means accepting or rejecting the connection request.

As described in the operation S102, the first Bluetooth device may determine whether the second Bluetooth device and the third Bluetooth device are the same device.

For the identity of the third Bluetooth device, there may be following two situations. One situation is that the third Bluetooth device is the second Bluetooth device, and the other situation is that the third Bluetooth device is not the second Bluetooth device, i.e., the third Bluetooth device is another Bluetooth device other than the second Bluetooth device. In a case where the third Bluetooth device is the second Bluetooth device, the first Bluetooth device establishing the BLE connection with the third Bluetooth device meets the connection relationship shown in FIG. 2. In a case where the third Bluetooth device is not the second Bluetooth device, the first Bluetooth device should not respond to the BLE connection request sent by the third Bluetooth device, otherwise the connection relationship shown in FIG. 1 may be established. Therefore, in this case, the first Bluetooth device should reject establishing the BLE connection with the third Bluetooth device.

In some embodiments, the first Bluetooth device may determine whether the second Bluetooth device and the third Bluetooth device are the same device by identifying the device information of the second Bluetooth device and the third Bluetooth device. The device information is information that may uniquely characterize the device's identity, which may be fixed or temporary. In Bluetooth technologies, the device information that may identify the device's identity may include a classic BT address, a BLE address, a device identity (ID), or an identity resolving key (IRK), etc., which are not limited here. The classic BT address is configured for the classic Bluetooth connection, and the BLE address and IRK are configured for the BLE connection.

In some embodiments, the first Bluetooth device may directly or indirectly obtain the device information of the second Bluetooth device and the device information of the third Bluetooth device. The direct method means that the device information is directly carried in the device interaction data, and the indirect method means that the device information is indirectly calculated or generated through a directly obtainable data element.

In some embodiments, during the initial pairing, the first Bluetooth device may obtain second device information of the second Bluetooth device based on the classic Bluetooth connection between the first Bluetooth device and the second Bluetooth device. For example, the first Bluetooth device may directly obtain a classic BT address, a device ID, or an IRK of the second Bluetooth device through a Bluetooth standard, or indirectly obtain a BLE address of the second Bluetooth device, which is not limited here. The obtaining of the second device information based on the classic Bluetooth connection may be performed during or after the establishment of the classic Bluetooth connection. The obtaining during the establishment of the classic Bluetooth connection means that the device information carried in the interaction data is obtained during the establishment of the classic Bluetooth connection. The obtaining after the establishment of the classic Bluetooth connection means that the device information transmitted through the data channel is obtained after the establishment of the classic Bluetooth connection.

In some embodiments, during the initial pairing, the first Bluetooth device may obtain device information of the third Bluetooth device based on the BLE connection request sent by the third Bluetooth device. For example, the Bluetooth standard stipulates that the BLE connection request carries a BLE address of the sender.

In some embodiments, the first Bluetooth device may determine whether the second Bluetooth device and the third Bluetooth device are the same device in the following way. In a case where the second device information of the second Bluetooth device matches the third device information of the third Bluetooth device, the first Bluetooth device may determine that the second Bluetooth device and the third Bluetooth device are the same device. Correspondingly, in a case where the second device information of the second Bluetooth device does not match the third device information of the third Bluetooth device (i.e., a mismatch occurs between the second device information and the third device information), the first Bluetooth device may determine that the second Bluetooth device and the third Bluetooth device are not the same device (i.e., the second Bluetooth device and the third Bluetooth device are different devices).

In some embodiments, the matching means that the second device information of the second Bluetooth device and the third device information of the third Bluetooth device indicates or directs to the same Bluetooth device. The determination of matching may be achieved by querying whether the second device information and the third device information are the same, or by querying whether the second device information and the third device information correspond to each other. For example, the first Bluetooth device may query whether the device ID of the second Bluetooth device is the same as the device ID of the third Bluetooth device, or may query whether the classic BT address of the second Bluetooth device corresponds to the BLE address of the third Bluetooth device.

In some embodiments, the second device information of the second Bluetooth device may include at least one of: the second classic BT address, the second BLE address, the second device ID, and the second IRK of the second Bluetooth device. The third device information of the third Bluetooth device may include at least one of: the third classic BT address, the third BLE address, the third device ID, and the third IRK of the third Bluetooth device. The dual-mode Bluetooth device may record the device information of a connected Bluetooth device, i.e., the Bluetooth device connected to the dual-mode Bluetooth device. In a case where the dual-mode device is connected to another dual-mode Bluetooth device, the dual-mode Bluetooth device may record the device information related to the classic Bluetooth and the device information related to the BLE.

As described in the operation S103, the first Bluetooth device may perform the response strategy for the BLE connection request based on the determination result.

Based on FIGS. 1 and 2 and the description mentioned above, the response strategy may include the following: in a case where the first Bluetooth device determines that the third Bluetooth device and the second Bluetooth device are the same device, the first Bluetooth device may respond to the BLE connection request from the third Bluetooth device to establish the connection relationship shown in FIG. 2 with the second Bluetooth device; and in a case where the first Bluetooth device determines that the third Bluetooth device and the second Bluetooth device are not the same device, the first Bluetooth device may not respond to or may reject the BLE connection request from the third Bluetooth device, otherwise the connection relationship shown in FIG. 1 will be established.

In some embodiments, in a case where the first Bluetooth device determines that the second Bluetooth device and the third Bluetooth device are the same device, the first Bluetooth device may respond to the BLE connection request and establish the BLE connection with the third Bluetooth device. Correspondingly, in a case where the first Bluetooth device determines that the second Bluetooth device and the third Bluetooth device are not the same device, the first Bluetooth device may reject the BLE connection request of the third Bluetooth device.

In some embodiments of the present disclosure, the first Bluetooth device may first establish the classic Bluetooth connection with the second Bluetooth device. In a case where the third Bluetooth device that sends the BLE connection request to the first Bluetooth device is the same as the second Bluetooth device, the first Bluetooth device may respond to the BLE connection request and establishes the BLE connection with the third Bluetooth device (i.e., the second Bluetooth device), ensuring that the first Bluetooth device and the second Bluetooth device may establish both the classic Bluetooth connection and the BLE connection, reducing the uncertainty of the dual-mode connection between dual-mode Bluetooth devices, and improving the user experience.

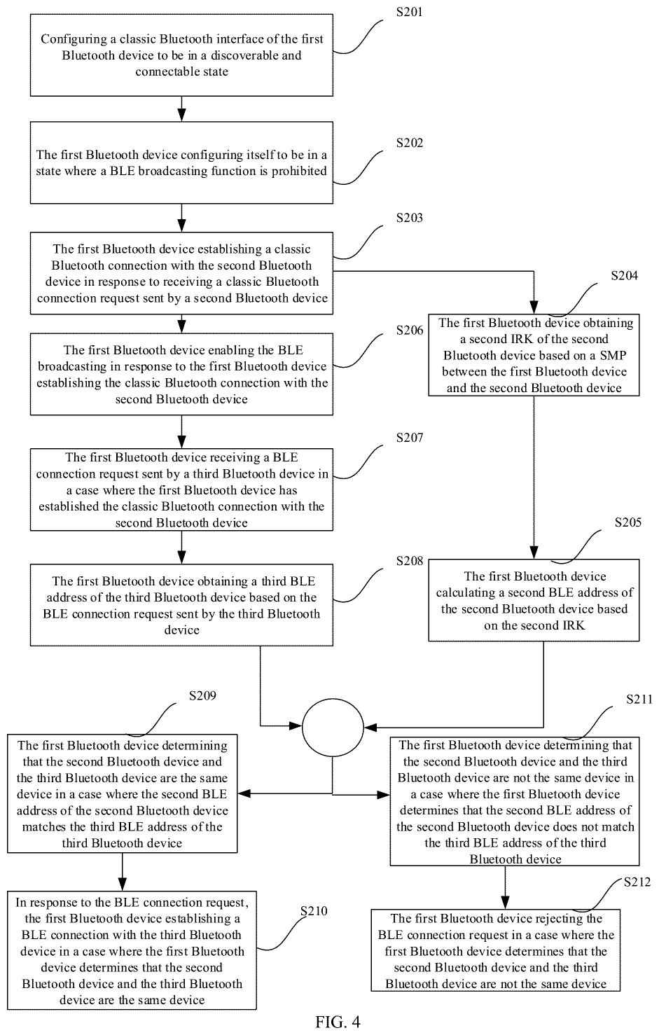

As shown in FIG. 4, in some embodiments, a device connection method is provided, and the device connection method may be applied to or performed by a first Bluetooth device. In this embodiment, the method may include the following operations.

An operation S201 includes: a first Bluetooth device configuring a classic Bluetooth interface thereof to be in a discoverable and connectable state.

An operation S202 includes: the first Bluetooth device configuring itself (i.e., the device connection method) to be in a state where the BLE broadcasting is prohibited or disabled.

An operation S203 includes: the first Bluetooth device establishing a classic Bluetooth connection with the second Bluetooth device in response to receiving a classic Bluetooth connection request sent by a second Bluetooth device.

An operation S204 includes: the first Bluetooth device obtaining a second IRK of the second Bluetooth device based on a security manager protocol (SMP) between the first Bluetooth device and the second Bluetooth device.

An operation S205 includes: the first Bluetooth device calculating a second BLE address of the second Bluetooth device based on the second IRK.

An operation S206 includes: the first Bluetooth device enabling the BLE broadcasting in response to the first Bluetooth device establishing the classic Bluetooth connection with the second Bluetooth device.

An operation S207 includes: the first Bluetooth device receiving a BLE connection request sent by a third Bluetooth device in a case where the first Bluetooth device has established the classic Bluetooth connection with the second Bluetooth device.

An operation S208 includes: the first Bluetooth device obtaining a third BLE address of the third Bluetooth device based on the BLE connection request sent by the third Bluetooth device.

An operation S209 includes: the first Bluetooth device determining that the second Bluetooth device and the third Bluetooth device are the same device in a case where the second BLE address of the second Bluetooth device matches the third BLE address of the third Bluetooth device.

An operation S210 includes: in response to the BLE connection request, the first Bluetooth device establishing a BLE connection with the third Bluetooth device in a case where the first Bluetooth device determines that the second Bluetooth device and the third Bluetooth device are the same device.

An operation S211 includes: the first Bluetooth device determining that the second Bluetooth device and the third Bluetooth device are not the same device in a case where the first Bluetooth device determines that the second BLE address of the second Bluetooth device does not match the third BLE address of the third Bluetooth device.

An operation S212 includes: the first Bluetooth device rejecting the BLE connection request in a case where the first Bluetooth device determines that the second Bluetooth device and the third Bluetooth device are not the same device.

The numbers of the above operations do not limit the performing sequences of the operations. The embodiments are only exemplary description, and those skilled in the art may adjust the performing sequences of the above operations within a reasonable range.

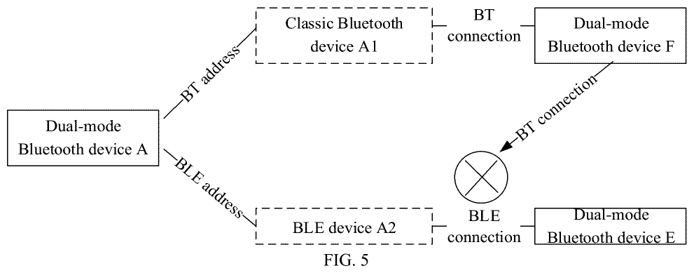

As shown in FIG. 5, the researcher founds that after the dual-mode Bluetooth device A performs dual-mode pairing connection with a dual-mode Bluetooth device E (i.e., the dual-mode Bluetooth device A establishes both the classic Bluetooth connection and the BLE connection with the dual-mode Bluetooth device E), in case that the dual-mode Bluetooth device A needs to perform an initial pairing with another dual-mode Bluetooth device F, the dual-mode Bluetooth device A is required to be configured in a pairing state. For a dual-mode Bluetooth device, the pairing state means that both classic Bluetooth and the BLE are configured in the pairing state, that is, the classic Bluetooth interface is in a discoverable and connectable state (simultaneously enabling an inquiry scan mode and a page scan mode), and the BLE interface is in a state of performing BLE broadcasting. In a case where the dual-mode Bluetooth device A acts as a peripheral device and the dual-mode Bluetooth devices E and F act as central devices, after the dual-mode Bluetooth device A enters the pairing state, since the BLE interface is still in the state of performing BLE broadcasting, if the device information of the dual-mode Bluetooth device A is not removed from a white list of the dual-mode Bluetooth device E, the dual-mode Bluetooth device E may be actively connected to the BLE interface of the dual-mode Bluetooth device A after scanning and finding the BLE broadcasting of the dual-mode Bluetooth device A. In this way, the dual-mode Bluetooth device F is unable to complete the BLE connection in the dual-mode pairing connection with the dual-mode Bluetooth device A. The user can only turn off or disable a BLE function of the dual-mode Bluetooth device E, or remove the device information of the dual-mode Bluetooth device A from the white list of the dual-mode Bluetooth device E, or keep the dual-mode Bluetooth device E out of a communication range of the dual-mode Bluetooth device A, which brings great inconvenience to the user, reduces the user experience, and even makes the user mistakenly believe that there is a product defect.

As described in the operation S201, the first Bluetooth device configures the classic Bluetooth interface of the first Bluetooth device to be in the discoverable and connectable state. As described in the operation S202, the first Bluetooth device configures itself to be in a state where the BLE broadcasting is prohibited or disabled.

In some embodiments, the first Bluetooth device is a dual-mode Bluetooth device.

In a case where the first Bluetooth device is required to be initially paired with a new device, the first Bluetooth device is configured in the pairing state. The initial pairing refers to the initial or first connection between the first Bluetooth device and another dual-mode Bluetooth device when no classic Bluetooth connection or BLE connection has been established between the first Bluetooth device and the another dual-mode Bluetooth device. After the initial pairing, both the first Bluetooth device and the another dual-mode Bluetooth device may record each other's device information (such as identity information). In some embodiments, the pairing state means that the classic Bluetooth interface is in a discoverable and connectable state, and the BLE interface is in a state where the BLE broadcasting is prohibited or disabled. An external device can discover the classic Bluetooth interface of the first Bluetooth device, but cannot discover the BLE interface of the first Bluetooth device. Therefore, when the first Bluetooth device is in the pairing state, the BLE interface will not be connected to a Bluetooth device which has ever been connected to the first Bluetooth device, and only the classic Bluetooth interface is discoverable at this time.

As described in the operation S203, the first Bluetooth device may establish a classic Bluetooth connection with the second Bluetooth device in response to a classic Bluetooth connection request sent by the second Bluetooth device.

The another Bluetooth device that needs to perform the initial pairing with the first Bluetooth device is the second Bluetooth device. In some embodiments, the second Bluetooth device is a dual-mode Bluetooth device.

The second Bluetooth device may be a device that needs to be initially paired with the first Bluetooth device. After scanning the classic Bluetooth interface of the first Bluetooth device, the second Bluetooth device may initiate establishment of a classic Bluetooth connection between the second Bluetooth device and the first Bluetooth device via user triggering, that is, the second Bluetooth device may send a classic Bluetooth connection request to the first Bluetooth device. The first Bluetooth device is in a discoverable and connectable state and may respond to the classic Bluetooth connection request. After receiving the classic Bluetooth connection request sent by the second Bluetooth device, the first Bluetooth device may respond to the request and establish a classic Bluetooth connection with the second Bluetooth device.

As described in the operation S204, the first Bluetooth device may obtain a second IRK of the second Bluetooth device based on a SMP between the first Bluetooth device and the second Bluetooth device.

During the process of the establishment of the classic Bluetooth connection between the first Bluetooth device and the second Bluetooth device, both the first and second Bluetooth devices are required to exchange security information based on the SMP. During the SMP interaction, the first Bluetooth device may directly obtain the second IRK of the second Bluetooth device. In some embodiments, the first Bluetooth device may obtain the second IRK of the second Bluetooth device through the SMP protocol of the Bluetooth standard rather than a non-standard method, thereby improving the compatibility of the method.

In some embodiments, the first Bluetooth device may record the second IRK of the second Bluetooth device. In subsequent operations, in case that a third Bluetooth device sends a BLE connection request and the BLE connection request carries a third IRK of the third Bluetooth device, the first Bluetooth device may directly check whether the second IRK and the third IRK are the same. In this way, there is no need to perform the operation of calculating the BLE address as described in the operation S205. In some embodiments, the comparison of IRKs mentioned above may be replaced by comparison of classic BT addresses, BLE addresses, or device IDs, etc.

As described in the operation S205, the first Bluetooth device may calculate a second BLE address of the second Bluetooth device based on the second IRK.

After obtaining the second IRK of the second Bluetooth device, the first Bluetooth device may calculate the second BLE address of the second Bluetooth device based on an IRK calculation rule. In some embodiments, the second BLE address calculated based on the second IRK is a resolvable private address (RPA). The Bluetooth standard stipulates that the RPA has 48 bits, and the lower 24 bits are obtained by hashing operation based on the IRK and a random number prand, i.e., Hash=ah (IRK, prand), and then the second BLE address is generated, i.e., RPA=hash∥prand. The random number remains unchanged during this round of communication.

As described in the operation S206, the first Bluetooth device may enable BLE broadcasting in response to establishing the classic Bluetooth connection with the second Bluetooth device.

In a case where the classic Bluetooth connection is established between the first Bluetooth device and the second Bluetooth device, the first Bluetooth device may enable the BLE broadcasting and begin receiving a BLE connection request. The first Bluetooth device may further identify whether the Bluetooth device sending the BLE connection request is the second Bluetooth device under the circumstances.

In some embodiments, the first Bluetooth device may enable the BLE broadcasting, that is, the first Bluetooth device may send the first BLE broadcast to the external. The first BLE broadcast is configured to indicate that the first Bluetooth device is capable of responding to a BLE connection request. The responding herein means to provide specific response to the BLE connection request, and the response may include agreeing to establish a connection or rejecting to establish the connection.

In some embodiments, the operation S206 may be replaced by: in a case where the second Bluetooth device is determined as a dual-mode Bluetooth device, the first Bluetooth device enabling the BLE broadcasting in a case where the classic Bluetooth connection is established between the first Bluetooth device and. There is a case where the first Bluetooth device is a dual-mode Bluetooth device, and the second Bluetooth device is a single-mode Bluetooth device that only supports the classic Bluetooth connection. In this case, the first Bluetooth device does not need to use its BLE interface when paired with the second Bluetooth device. Even if the first Bluetooth device enables its BLE interface, the second Bluetooth device does not support the connection. Thus, the first Bluetooth device may be used as a single-mode Bluetooth device in this case. To reduce unnecessary power consumption, only in a case where the first Bluetooth device determines that the second Bluetooth device is a dual-mode Bluetooth device, will the first Bluetooth device be triggered to enable the BLE broadcasting in response to completing the establishment of the classic Bluetooth connection.

In some embodiments, the first Bluetooth device may identify whether the second Bluetooth device is a dual-mode Bluetooth device through class of device (COD) information in the process of establishing the classic Bluetooth connection with the second Bluetooth device.

In some embodiments, the first Bluetooth device may determine or query whether the second Bluetooth device is a dual-mode Bluetooth device through a service discovery protocol (SDP) after establishing the classic Bluetooth connection with the second Bluetooth device.

As described in the operation S207, the first Bluetooth device may receive a BLE connection request sent by a third Bluetooth device in a case where the first Bluetooth device have established the classic Bluetooth connection with the second Bluetooth device.

As described in the operation S208, the first Bluetooth device may obtain a third BLE address of the third Bluetooth device based on the BLE connection request sent by the third Bluetooth device.

In some embodiments, the BLE connection request sent by the third Bluetooth device directly may directly carry the third BLE address of the third Bluetooth device, and the first Bluetooth device may directly obtain the third BLE address and compare the third BLE address with the second BLE address calculated in the operation S205.

In some embodiments, based on the Bluetooth standard, the BLE connection request sent by the third Bluetooth device may carry the third IRK of the third Bluetooth device. After obtaining the third IRK of the third Bluetooth device, the first Bluetooth device may calculate the third BLE address of the third Bluetooth device based on the IRK calculation rule.

In some embodiments, the first Bluetooth device may perform the response strategy for the BLE connection request based on the comparison result of the second BLE address and the third BLE address.

As described in the operation S209, the first Bluetooth device may determine that the second Bluetooth device and the third Bluetooth device are the same device in a case where the second BLE address of the second Bluetooth device matches the third BLE address of the third Bluetooth device.

Based on a determination that the second Bluetooth device and the third Bluetooth device are the same device, the subsequent operation S210 is performed.

In some embodiments, the matching means that the second BLE address and the third BLE address are the same.

As described in the operation S210, based on a determination that the second Bluetooth device and the third Bluetooth device are the same device, the first Bluetooth device may establish a BLE connection with the third Bluetooth device in response to the BLE connection request. In this way, the first Bluetooth device and the second Bluetooth device may establish the connection relationship shown in FIG. 2.

As described in the operation S211, the first Bluetooth device may determine that the second Bluetooth device and the third Bluetooth device are not the same device in a case where the second BLE address of the second Bluetooth device does not match the third BLE address of the third Bluetooth device.

Based on a determination that the second Bluetooth device and the third Bluetooth device are not the same device, the subsequent operation S212 is performed.

As described in the operation S212, in a case where the first Bluetooth device determines the second Bluetooth device and the third Bluetooth device are not the same device, the first Bluetooth device may reject the BLE connection request.

In some embodiments of the present disclosure, when the first Bluetooth device is in the pairing state (the pairing state described here initially prohibits the enabling of the BLE broadcasting, which may be called a first pairing state), the first Bluetooth device may first establish the classic Bluetooth connection with the second Bluetooth device. In a case where the third Bluetooth device sending the BLE connection request to the first Bluetooth device is the same as the second Bluetooth device, the first Bluetooth device may respond to the BLE connection request and establish the BLE connection with the third Bluetooth device (i.e., the second Bluetooth device), ensuring that the first Bluetooth device and the second Bluetooth device may establish both the classic Bluetooth connection and the BLE connection, reducing the occurrence that the BLE interface is preemptively connected with a previously connected Bluetooth device in a case where a dual-mode Bluetooth device is required to be initially paired with another dual-mode Bluetooth device, thereby reducing the inability of completing the re-pairing of the dual-mode Bluetooth device with the another dual-mode Bluetooth device, and improving the user experience.

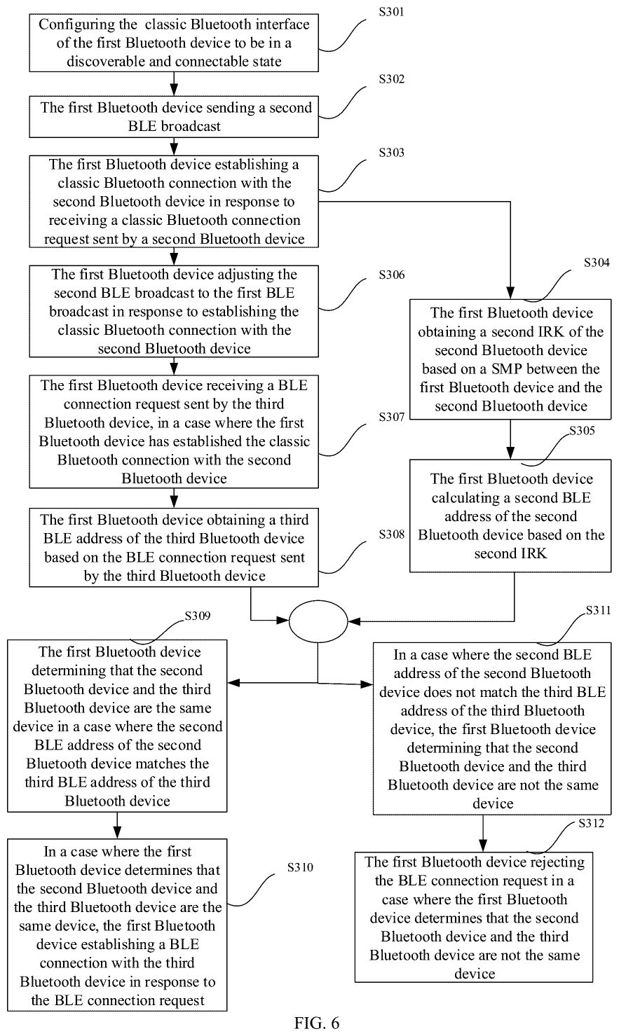

As shown in FIG. 6, in other embodiments, a device connection method is provided. The device connection method may be applied to or performed by the first Bluetooth device. In some embodiments, the method may include the following operations.

An operation S301 includes: a first Bluetooth device configuring the classic Bluetooth interface thereof to be in a discoverable and connectable state.

An operation S302 includes: the first Bluetooth device sending a second BLE broadcast.

The second BLE broadcast may be configured to indicate a Bluetooth device that scans the second BLE broadcast to display device discovery information.

An operation S303 includes: the first Bluetooth device establishing a classic Bluetooth connection with the second Bluetooth device in response to receiving a classic Bluetooth connection request sent by a second Bluetooth device.

An operation S304 includes: the first Bluetooth device obtaining a second IRK of the second Bluetooth device based on a SMP between the first Bluetooth device and the second Bluetooth device.

An operation S305 includes: the first Bluetooth device calculating a second BLE address of the second Bluetooth device based on the second IRK.

An operation S306 includes: the first Bluetooth device adjusting the second BLE broadcast to the first BLE broadcast in response to establishing the classic Bluetooth connection with the second Bluetooth device.

The first BLE broadcast may be configured to indicate that the first Bluetooth device is capable of responding to a BLE connection request.

An operation S307 includes: the first Bluetooth device receiving a BLE connection request sent by the third Bluetooth device, in a case where the first Bluetooth device has established the classic Bluetooth connection with the second Bluetooth device.

An operation S308 includes: the first Bluetooth device obtaining a third BLE address of the third Bluetooth device based on the BLE connection request sent by the third Bluetooth device.

An operation S309 includes: the first Bluetooth device determining that the second Bluetooth device and the third Bluetooth device are the same device in a case where the second BLE address of the second Bluetooth device matches the third BLE address of the third Bluetooth device.

An operation S310 includes: in a case where the first Bluetooth device determines that the second Bluetooth device and the third Bluetooth device are the same device, the first Bluetooth device establishing a BLE connection with the third Bluetooth device in response to the BLE connection request.

An operation S311 includes: in a case where the second BLE address of the second Bluetooth device does not match the third BLE address of the third Bluetooth device, the first Bluetooth device determining that the second Bluetooth device and the third Bluetooth device are not the same device.

An operation S312 includes: the first Bluetooth device rejecting the BLE connection request in a case where the first Bluetooth device determines that the second Bluetooth device and the third Bluetooth device are not the same device.

The numbers of the above operations do not limit the performing sequences of the operations. The embodiments are only exemplary description, and those skilled in the art may adjust the performing sequences of the above operations within a reasonable range.

The researcher further founds that in the embodiment shown in FIG. 4, if the BLE broadcasting of the first Bluetooth device is prohibited or disabled in a case where the first Bluetooth device enters the pairing state, the second Bluetooth device cannot be triggered to display device discovery information about the first Bluetooth device. In the related art, to allow the user to timely discover, through the second Bluetooth device, that the first Bluetooth device is in the pairing state and allow the user to trigger or initiate a pairing connection, the first Bluetooth device is required to send the second BLE broadcast in the pairing state to trigger a Bluetooth device (such as the second Bluetooth device) that receives the BLE broadcast to display the device discovery information. The device discovery information is prompt information, such as a pop-up window. However, since the BLE broadcast carries device information of the first Bluetooth device, a Bluetooth device that have been previously connected to the first Bluetooth device will initiate establishment of the BLE connection between the previously connected Bluetooth device and the first Bluetooth device after scanning and finding the BLE broadcast, leading to subsequent pairing confusion. To solve the above problem, the researcher proposes another device connection method.

As described in the operation S301, the first Bluetooth device may configure the classic Bluetooth interface thereof to be in a discoverable and connectable state. The principle in this operation is basically the same as the principle described in the operation S201, and is not repeated here.

As described in the operation S302, the first Bluetooth device may send a second BLE broadcast. The second BLE broadcast may be configured to indicate a Bluetooth device that scans the second BLE broadcast to display device discovery information.

In some embodiments, the second BLE broadcast is a directed broadcasting message. A target address of the directed broadcasting message may be configured as a specified value, and the specified value should avoid pointing to any device, for example, the specified value may be FF:FF:FF:FF:FF:FF. An external Bluetooth device, such as the second Bluetooth device, will not initiate establishment of a BLE connection with the first Bluetooth device after receiving the second BLE broadcast because the second BLE broadcast carries a target address that does not point to the second Bluetooth device. In addition, since the target address is the specified value, after identifying that the target address is the specified value, the second Bluetooth device may trigger the display of the device discovery information.

As described in the operation S303, the first Bluetooth device may establish a classic Bluetooth connection with the second Bluetooth device in response to receiving a classic Bluetooth connection request sent by a second Bluetooth device. The principle in this operation is basically the same as the principle described in the operation S203, and is not repeated here.

As described in the operation S304, the first Bluetooth device may obtain a second IRK of the second Bluetooth device based on a SMP between the first Bluetooth device and the second Bluetooth device. The principle in this operation is basically the same as the principle described in the operation S204, and is not repeated here.

As described in the operation S305, the first Bluetooth device may calculate a second BLE address of the second Bluetooth device based on the second IRK. The principle in this operation is basically the same as the principle described in the operation S205, and is not repeated here.

As described in the operation S306, the first Bluetooth device may change or adjust the second BLE broadcast to the first BLE broadcast in response to establishing the classic Bluetooth connection with the second Bluetooth device.

After establishing the classic Bluetooth connection with the second Bluetooth device, the first Bluetooth device may only agree to establish a BLE connection in a case where a Bluetooth device that subsequently sends the BLE connection request is the second Bluetooth device and the second Bluetooth device is a dual-mode Bluetooth device. Therefore, the first Bluetooth device may change the second BLE broadcast to the first BLE broadcast. The first BLE broadcast is configured to indicate that the first Bluetooth device is capable of responding to the BLE connection request. After receiving the first BLE broadcast, the second Bluetooth device may send the BLE connection request to the first Bluetooth device.

In some embodiments, in case that the second Bluetooth device is a single-mode Bluetooth device that only supports a classic Bluetooth, the first Bluetooth device does not need to enable the BLE broadcasting. In this case, the first Bluetooth device and the second Bluetooth device may only establish the classic Bluetooth connection, and there is no need to continue with subsequent operations. However, in a case where the first Bluetooth device determines that the second Bluetooth device is a dual-mode Bluetooth device, the first Bluetooth device changes the second BLE broadcast to the first BLE broadcast in a case where the classic Bluetooth connection with the second Bluetooth device.

As described in the operation S307, the first Bluetooth device may receive a BLE connection request sent by the third Bluetooth device, in a case where the first Bluetooth device has established the classic Bluetooth connection with the second Bluetooth device. The principle in this operation is basically the same as the principle described in the operation S207, and is not repeated here.

As described in the operation S308, the first Bluetooth device may obtain a third BLE address of the third Bluetooth device based on the BLE connection request sent by the third Bluetooth device. The principle in this operation is basically the same as the principle described in the operation S208, and is not repeated here.

As described in the operation S309, the first Bluetooth device may determine that the second Bluetooth device and the third Bluetooth device are the same device, in a case where the second BLE address of the second Bluetooth device matches the third BLE address of the third Bluetooth device. The principle in this operation is basically the same as the principle described in the operation S209, and is not repeated here.

As described in the operation S310, in a case where the first Bluetooth device determines that the second Bluetooth device and the third Bluetooth device are the same device, the first Bluetooth device may establish a BLE connection with the third Bluetooth device in response to the BLE connection request. The principle in this operation is basically the same as the principle described in the operation S210, and is not repeated here.

As described in the operation S311, in a case where the second BLE address of the second Bluetooth device does not match the third BLE address of the third Bluetooth device, the first Bluetooth device may determine that the second Bluetooth device and the third Bluetooth device are not the same device. The principle in this operation is basically the same as the principle described in the operation S211, and is not repeated here.

As described in the operation S312, the first Bluetooth device may reject the BLE connection request in a case where the first Bluetooth device determines that the second Bluetooth device and the third Bluetooth device are not the same device. The principle in this operation is basically the same as the principle described in the operation S212, and is not repeated here.

In some embodiments of the present disclosure, when the first Bluetooth device is in the pairing state (the pairing state described here does not initially prohibit enabling the BLE broadcasting, which may be called a second pairing state), the first Bluetooth device may send the second BLE broadcast configured to only trigger the display of the device discovery information. After establishing the classic Bluetooth connection with the second Bluetooth device, the first Bluetooth device may change the second BLE broadcast to the first BLE broadcast, so that the third Bluetooth device may send the BLE connection request to the first Bluetooth device. In a case where the third Bluetooth device is the same as the second Bluetooth device, the first Bluetooth device responds to the BLE connection request and establishes the BLE connection with the third Bluetooth device (i.e., the second Bluetooth device), ensuring that the first Bluetooth device and the second Bluetooth device may establish both the classic Bluetooth connection and the BLE connection, reducing the occurrence that the BLE interface is preemptively connected with a previously connected Bluetooth device in a case where a dual-mode Bluetooth device intends to perform the initial pairing with another dual-mode Bluetooth device, thereby reducing the inability of completing the re-pairing of the dual-mode Bluetooth device with the another dual-mode Bluetooth device, and improving the user experience.

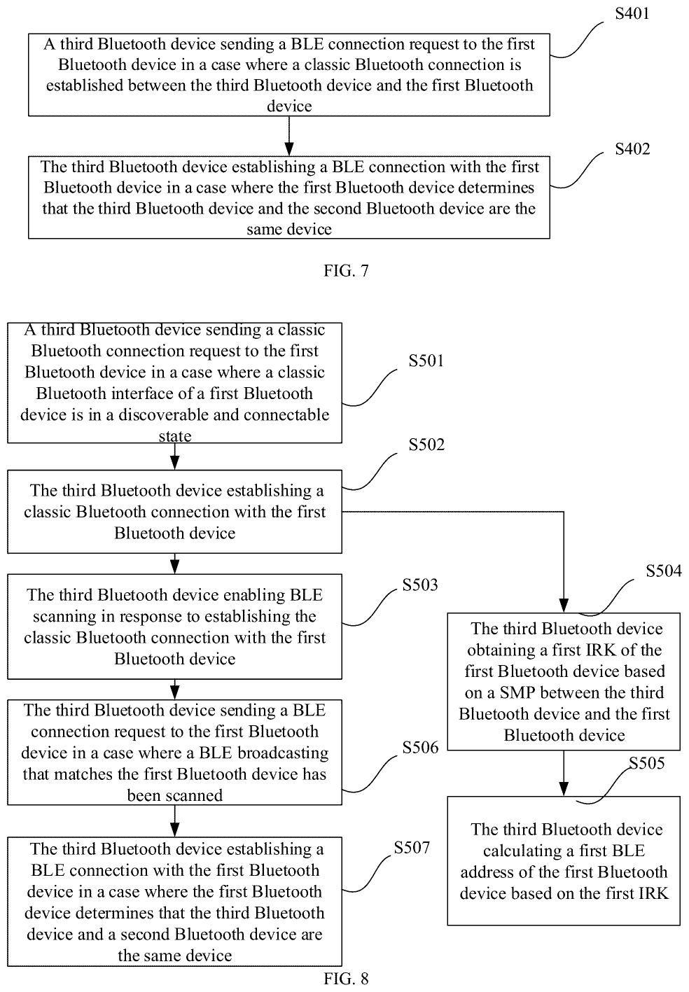

As shown in FIG. 7, in other embodiments, a device connection method is provided. The device connection method may be applied to or performed by a third Bluetooth device. In some embodiments, the method may include the following operations.

An operation S401 includes: a third Bluetooth device sending a BLE connection request to the first Bluetooth device in a case where the third Bluetooth device has established a classic Bluetooth connection with the first Bluetooth device.

An operation S402 includes: the third Bluetooth device establishing a BLE connection with the first Bluetooth device in a case where the first Bluetooth device determines that the third Bluetooth device and the second Bluetooth device are the same device.

The second Bluetooth device is a Bluetooth device that establishes a classic Bluetooth connection with the first Bluetooth device.

This embodiment is related to the embodiment shown in FIG. 3, and some related descriptions are not repeated here.

As described in the operation S401, the third Bluetooth device may send the BLE connection request to the first Bluetooth device in a case where the classic Bluetooth connection is established between the third Bluetooth device and the first Bluetooth device.

In some embodiments, the first Bluetooth device and the third Bluetooth device may be dual-mode Bluetooth devices. In a case where the user operates the third Bluetooth device to establish the classic Bluetooth connection with the first Bluetooth device, the third Bluetooth device is required to continue to establish the BLE connection with the first Bluetooth device, only in this way can the dual-mode connection between the third Bluetooth device and the first Bluetooth device be completed.

In some embodiments, the third Bluetooth device may send the BLE connection request to the first Bluetooth device only in a case where the third Bluetooth device scans and finds a BLE broadcast that matches the first Bluetooth device.

In some embodiments, the third Bluetooth device may first obtain first device information of the first Bluetooth device based on the classic Bluetooth connection between the third Bluetooth device and the first Bluetooth device, and then obtain fourth device information based on the scanned BLE broadcast. The fourth device information is device information of a fourth Bluetooth device that sends the BLE broadcast. In a case where the first device information matches the fourth device information, it is determined that the scanned BLE broadcast matches the first Bluetooth device.

In some embodiments, the first device information may include at least one of: a first classic BT address, a first BLE address, a first device ID, and a first IRK of the first Bluetooth device.

In some embodiments, the fourth device information may include at least one of: a fourth classic BT address, a fourth BLE address, a fourth device ID, and a fourth IRK of the fourth Bluetooth device.

In some embodiments, in case that the third Bluetooth device is a central device (such as a mobile phone) and the first Bluetooth device is a peripheral device (such as a earphone), the classic BT address and the BLE address of the first Bluetooth device may be set to the same, called a public address. In this case, the third Bluetooth device may obtain the first device information of the first Bluetooth device based on the classic Bluetooth connection between the third Bluetooth device and the first Bluetooth device. In a case where the first classic BT address is obtained, the third Bluetooth device may also obtain the first BLE address.

As described in the operation S402, the third Bluetooth device may establish the BLE connection with the first Bluetooth device in a case that the first Bluetooth device determines that the third Bluetooth device and the second Bluetooth device are the same device.

The second Bluetooth device is a Bluetooth device that has established the classic Bluetooth connection with the first Bluetooth device. That is, in a case where the classic Bluetooth connection is established between the third Bluetooth device and the first Bluetooth device, when the third Bluetooth device sends the BLE connection request to the first Bluetooth device, the first Bluetooth device may determine whether the third Bluetooth device that initiates establishment of the BLE connection is the same as the second Bluetooth device that has currently established the classic Bluetooth connection with the first Bluetooth device. In a case where the third Bluetooth device is the same as the second Bluetooth device, the first Bluetooth device may respond to the BLE connection request and establish the BLE connection with the third Bluetooth device, thereby achieving the dual-mode pairing between the first Bluetooth device and the third Bluetooth device.

In some embodiments of the present disclosure, the first Bluetooth device may first establish the classic Bluetooth connection with the second Bluetooth device. In a case where the third Bluetooth device sends the BLE connection request to the first Bluetooth device and the first Bluetooth device determines that the third Bluetooth device is the same as the second Bluetooth device, the first Bluetooth device may respond to the BLE connection request and establish a BLE connection with the third Bluetooth device (i.e., the second Bluetooth device), ensuring that the first Bluetooth device and the second Bluetooth device may establish both the classic Bluetooth connection and the BLE connection therebetween, reducing the uncertainty of the dual-mode connection between the dual-mode Bluetooth devices, and improving the user experience.

As shown in FIG. 8, in other embodiments, a device connection method is provided. The device connection method may be applied to or performed by a third Bluetooth device. In some embodiments, the method may include the following operations.

An operation S501 includes: a third Bluetooth device sending a classic Bluetooth connection request to the first Bluetooth device in a case where a classic Bluetooth interface of a first Bluetooth device is in a discoverable and connectable state.

An operation S502 includes: the third Bluetooth device establishing a classic Bluetooth connection with the first Bluetooth device.

An operation S503 includes: the third Bluetooth device enabling BLE scanning in response to establishing the classic Bluetooth connection with the first Bluetooth device.

An operation S504 includes: the third Bluetooth device obtaining a first IRK of the first Bluetooth device based on a SMP between the third Bluetooth device and the first Bluetooth device.

An operation S505 includes: the third Bluetooth device calculating a first BLE address of the first Bluetooth device based on the first IRK.

An operation S506 includes: the third Bluetooth device sending a BLE connection request to the first Bluetooth device in a case where a BLE broadcast that matches the first Bluetooth device has been scanned.

An operation S507 includes: the third Bluetooth device establishing a BLE connection with the first Bluetooth device in a case where the first Bluetooth device determines that the third Bluetooth device and a second Bluetooth device are the same device.

The second Bluetooth device is a Bluetooth device that establishes a classic Bluetooth connection with the first Bluetooth device.

As described in the operation S501, the third Bluetooth device may send the classic Bluetooth connection request to the first Bluetooth device in a case where the classic Bluetooth interface of the first Bluetooth device is in the discoverable and connectable state.

In some embodiments, the first Bluetooth device is a dual-mode Bluetooth device.

In a case where the first Bluetooth device is required to be initially paired with a new device, the first Bluetooth device is configured in a pairing state. The initial pairing refers to the initial or first connection between the first Bluetooth device and another dual-mode Bluetooth device in a case where no classic Bluetooth connection or BLE connection has been ever established between the first Bluetooth device and the another Bluetooth device. After the initial pairing, both the first Bluetooth device and the another Bluetooth device may record each other's device information (such as identity information). In some embodiments, the pairing state means that the classic Bluetooth interface is in the discoverable and connectable state and the BLE interface is in a state where the BLE broadcasting is prohibited or disabled. An external device is capable of discovering the classic Bluetooth interface of the first Bluetooth device, but is uncapable of discovering the BLE interface. Therefore, in a case where the first Bluetooth device is in the pairing state, the BLE interface will not be connected to a Bluetooth device which has ever been connected to the first Bluetooth device, and only the classic Bluetooth interface is discoverable.

In some embodiments, the first Bluetooth device may not prohibit or disable the BLE broadcasting in the pairing state but send the second BLE broadcast. The third Bluetooth device may display the device discovery information in response to receiving the second BLE broadcast sent by the first Bluetooth device. The second BLE broadcast is configured to indicate a Bluetooth device which has scanned and found the second BLE broadcast to display the device discovery information. After the classic Bluetooth connection is established between the first Bluetooth device and a certain Bluetooth device, the first Bluetooth device may change the second BLE broadcast to the first BLE broadcast. The first BLE broadcast is configured to indicate the Bluetooth device which has scanned and found the first BLE broadcast that, the first Bluetooth device is capable of responding to the BLE connection request.

In some embodiments, the second BLE broadcast may be the directed broadcasting message, and a target address of the directed broadcasting message may be configured as a specified value, for example, the specified value may be FF:FF:FF:FF:FF:FF.

As described in the operation S502, the third Bluetooth device may establish the classic Bluetooth connection with the first Bluetooth device.

In some embodiments, the third Bluetooth device is a dual-mode Bluetooth device.

In this embodiment, the third Bluetooth device is a device that is required to be initially paired with the first Bluetooth device. After scanning and finding the classic Bluetooth interface of the first Bluetooth device, the third Bluetooth device may initiate the establishment of the classic Bluetooth connection between the third Bluetooth device and the first Bluetooth device via user triggering, that is, the third Bluetooth device may send the classic Bluetooth connection request to the first Bluetooth device. The first Bluetooth device is in the discoverable and connectable state and may respond to the classic Bluetooth connection request. After receiving the classic Bluetooth connection request sent by the third Bluetooth device, the first Bluetooth device may respond to the request and establish the classic Bluetooth connection with the third Bluetooth device.

As described in the operation S503, the third Bluetooth device may enable the BLE scanning in response to establishing the classic Bluetooth connection with the first Bluetooth device.

In some embodiments, the third Bluetooth device may prohibit the BLE scanning before the classic Bluetooth connection is established between the third Bluetooth device and the first Bluetooth device. Since the BLE connection is needed only after the classic Bluetooth connection is established, this process arrangement may save power consumption of the third Bluetooth device.

In some embodiments, the third Bluetooth device may enable the BLE scanning in response to establishing the classic Bluetooth connection with the first Bluetooth device and identifying that the first Bluetooth device is a dual-mode Bluetooth device. That is, in a case where the first Bluetooth device is not a dual-mode Bluetooth device, even if the classic Bluetooth connection is established between the third Bluetooth device and the first Bluetooth device, there is no need for the third Bluetooth device to enable the BLE scanning. This process arrangement may further save the power consumption of the third Bluetooth device.

As described in the operation S504, the third Bluetooth device may obtain a first IRK of the first Bluetooth device based on a SMP between the third Bluetooth device and the first Bluetooth device.

During the process of establishing the classic Bluetooth connection between the first Bluetooth device and the third Bluetooth device, both the first Bluetooth device and the third Bluetooth device are required to exchange security information based on the SMP. During the SMP exchange, the third Bluetooth device may directly obtain the first IRK of the first Bluetooth device. In some embodiments, the third Bluetooth device may obtain the first IRK of the first Bluetooth device through the SMP protocol of the Bluetooth standard rather than a non-standard method, thereby improving the compatibility of the method.

In some embodiments, the third Bluetooth device may record the first IRK of the first Bluetooth device. In subsequent operations, when the first Bluetooth device sends a BLE Bluetooth broadcast, in a case where the third Bluetooth device scans another first IRK of the first Bluetooth device carried in the BLE Bluetooth broadcast, the third Bluetooth device may directly compare and determine whether the recorded first IRK and the another scanned first IRK are the same, so that there is no need to perform the operation of calculating the BLE address as described in the operation S505. In some embodiments, the comparison of IRKs mentioned above may be replaced by comparison of classic BT addresses, BLE addresses, device IDs, etc.

As described in the operation S505, the third Bluetooth device may calculate the first BLE address of the first Bluetooth device based on the first IRK.

After obtaining the first IRK of the first Bluetooth device, the third Bluetooth device may calculate the first BLE address of the first Bluetooth device based on an IRK calculation rule. In some embodiments, the first BLE address calculated based on the first IRK may be an RPA. The Bluetooth standard stipulates that the RPA has 48 bits, and the lower 24 bits are obtained by hashing operation based on the IRK and the random number prand, i.e., Hash=ah (IRK, prand), and then the first BLE address is generated, i.e., RPA=hash∥prand. The random number remains unchanged during this round of communication.

In some embodiments, the third Bluetooth device may write the device information of the first Bluetooth device into the white list.

As described in the operation S506, the third Bluetooth device may send the BLE connection request to the first Bluetooth device in response to scanning and finding the BLE broadcast that matches the first Bluetooth device.

The BLE connection request sent by the third Bluetooth device carries the third IRK of the third Bluetooth device. After receiving the BLE connection request and obtaining the third IRK of the third Bluetooth device, the first Bluetooth device may calculate the third BLE address of the third Bluetooth device based on the IRK calculation rule.

As described in the operation S507, the third Bluetooth device may establish the BLE connection with the first Bluetooth device in a case where the first Bluetooth device determines that the third Bluetooth device and a second Bluetooth device are the same device.

The second Bluetooth device is a Bluetooth device that has established the classic Bluetooth connection with the first Bluetooth device. In this embodiment, for the first Bluetooth device, it is necessary to first assume that the first Bluetooth device has established the classic Bluetooth connection with the second Bluetooth device, since the BLE broadcasting is enabled, the received BLE connection request may come from a Bluetooth device other than the second Bluetooth device. Therefore, the device that first establishes the classic Bluetooth connection with the first Bluetooth device is called the second Bluetooth device. In fact, in this embodiment, the second Bluetooth device is the third Bluetooth device.

When the second BLE address of the second Bluetooth device matches the third BLE address of the third Bluetooth device, the first Bluetooth device may determine that the second Bluetooth device and the third Bluetooth device are the same device. Based on the determination that the second Bluetooth device and the third Bluetooth device are the same device, the first Bluetooth device may establish the BLE connection with the third Bluetooth device in response to the BLE connection request. In this way, the first Bluetooth device and the third Bluetooth device may establish the connection relationship shown in FIG. 2.

In some embodiments of the present disclosure, when the first Bluetooth device is in the pairing state (the pairing state described here initially prohibits the enabling of the BLE broadcasting, which may be called the first pairing state), the first Bluetooth device may first establish the classic Bluetooth connection with the second Bluetooth device. In a case where the third Bluetooth device sending the BLE connection request to the first Bluetooth device is the same as the second Bluetooth device, the first Bluetooth device responds to the BLE connection request and establishes the BLE connection with the third Bluetooth device (i.e., the second Bluetooth device), ensuring that the first Bluetooth device and the second Bluetooth device may establish both the classic Bluetooth connection and the BLE connection, reducing the occurrence that the BLE interface is preemptively connected with a previously connected Bluetooth device in a case where a dual-mode Bluetooth device intends to perform the initial pairing with another dual-mode Bluetooth device, thereby reducing the inability of completing the re-pairing of the dual-mode Bluetooth device with the another dual-mode Bluetooth device, and improving the user experience.

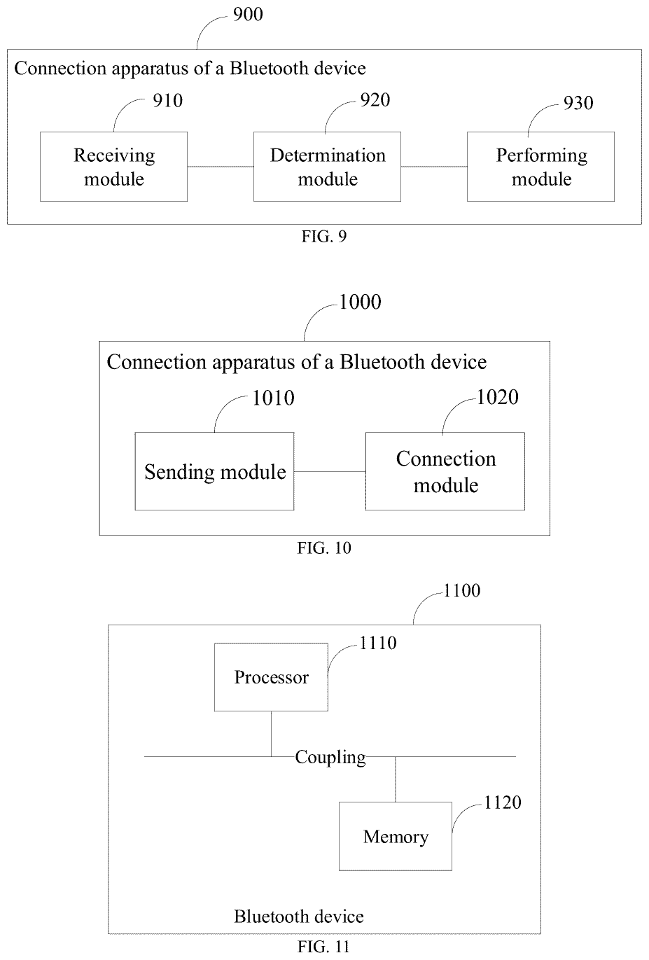

As shown in FIG. 9, in some embodiments, a device connection apparatus 900 may be provided. The device connection apparatus 900 may be configured in a first Bluetooth device. The first Bluetooth device may be a dual-mode Bluetooth device. The device connection apparatus 900 of the first Bluetooth device may include a receiving module 910, a determination module 920, and a performing module 930.

The receiving module 910 is configured to receive a BLE connection request sent by a third Bluetooth device in a case where a classic Bluetooth connection is established between the first Bluetooth device and a second Bluetooth device.

The determination module 920 is configured to determine whether the second Bluetooth device and the third Bluetooth device are the same device.

The performing module 930 is configured to perform a response strategy for the BLE connection request based on a determination result.

In some embodiments, the second Bluetooth device may be a dual-mode Bluetooth device.

The first Bluetooth device may first establish a classic Bluetooth connection with the second Bluetooth device. A classic Bluetooth interface of one of the first Bluetooth device and the second Bluetooth device is configured in a connectable state, and the other of the first Bluetooth device and the second Bluetooth device may scan and initiate establishment of a connection to establish the classic Bluetooth connection between the first Bluetooth device and the second Bluetooth device.

After the classic Bluetooth connection is established between the first Bluetooth device and the second Bluetooth device, the first Bluetooth device and the second Bluetooth device may further establish a BLE connection therebetween. In some embodiments, the second Bluetooth device may initiate the establishment of the BLE connection. In other embodiments, the first Bluetooth device may initiate the establishment of the BLE connection.

Taking the second Bluetooth device initiating the establishment of the BLE connection as an example, the first Bluetooth device, while performing BLE broadcasting, receives a BLE connection request sent by the third Bluetooth device (which may be the second Bluetooth device) through the receiving module 910. The BLE broadcast is a message broadcasted by the first Bluetooth device in a case where the first Bluetooth device acts as a peripheral device, and the BLE broadcast is configured to indicate a central device which scans and finds the BLE broadcast that the first Bluetooth device is capable of responding to a BLE connection request sent by the central device. The responding herein means accepting or rejecting the connection request.

Then, the determination module 920 may determine whether the second Bluetooth device and the third Bluetooth device are the same device.

For the identity of the third Bluetooth device, there may be following two situations. One situation is that the third Bluetooth device is the second Bluetooth device, and the other situation is that the third Bluetooth device is not the second Bluetooth device. In a case where the third Bluetooth device is the second Bluetooth device, the first Bluetooth device establishing the BLE connection with the third Bluetooth device meets the connection relationship shown in FIG. 2. In a case where the third Bluetooth device is not the second Bluetooth device, the first Bluetooth device should not respond to the BLE connection request sent by the third Bluetooth device, otherwise the connection relationship shown in FIG. 1 may be established. Therefore, in this case, the first Bluetooth device should reject establishing the BLE connection with the third Bluetooth device.

In some embodiments, the determination module 920 may determine whether the second Bluetooth device and the third Bluetooth device are the same device by identifying device information of the second Bluetooth device and the third Bluetooth device.

In some embodiments, the connection apparatus 900 may include a first obtaining module. The first obtaining module may directly or indirectly obtain the device information of the second Bluetooth device and the device information of the third Bluetooth device. The direct method means that the device information is directly carried in the device interaction data, and the indirect method means that the device information is indirectly calculated or generated through a directly obtainable data element.

In some embodiments, during the initial pairing, the first obtaining module may obtain second device information of the second Bluetooth device based on the classic Bluetooth connection between the first Bluetooth device and the second Bluetooth device. For example, the first obtaining module may directly obtain a classic BT address, a device ID, or an IRK of the second Bluetooth device through a Bluetooth standard, or indirectly obtain a BLE address of the second Bluetooth device, which is not limited here. The obtaining of the second device information based on the classic Bluetooth connection may be performed during or after the establishment of the classic Bluetooth connection. The obtaining during the establishment of the classic Bluetooth connection means that the device information carried in the interaction data is obtained during the establishment of the classic Bluetooth connection. The obtaining after the establishment of the classic Bluetooth connection means that the device information transmitted through the data channel is obtained after the establishment of the classic Bluetooth connection.

In some embodiments, the connection apparatus 900 may further include a second obtaining module. During the initial pairing, the second obtaining module may obtain device information of the third Bluetooth device based on the BLE connection request sent by the third Bluetooth device. For example, the Bluetooth standard stipulates that the BLE connection request carries a BLE address of the sender.

In some embodiments, the determination module 920 may determine whether the second Bluetooth device and the third Bluetooth device are the same device in the following way. In a case where the second device information of the second Bluetooth device matches the third device information of the third Bluetooth device, the determination module 920 may determine that the second Bluetooth device and the third Bluetooth device are the same device. Correspondingly, in a case where the second device information of the second Bluetooth device does not match the third device information of the third Bluetooth device (i.e., the second device information and the third device information mismatch), the determination module 920 may determine that the second Bluetooth device and the third Bluetooth device are not the same device.

In some embodiments, the matching means that the second device information of the second Bluetooth device and the third device information of the third Bluetooth device indicates or directs to the same Bluetooth device. The determination of matching may be achieved by querying whether the second device information and the third device information are the same, or by querying whether the second device information and the third device information correspond to each other. For example, the determination module 920 may query whether the device ID of the second Bluetooth device is the same as the device ID of the third Bluetooth device, or may query whether the classic BT address of the second Bluetooth device corresponds to the BLE address of the third Bluetooth device.

In some embodiments, the second device information of the second Bluetooth device may include at least one of: the second classic BT address, the second BLE address, the second device ID, and the second IRK of the second Bluetooth device. The third device information of the third Bluetooth device may include at least one of: the third classic BT address, the third BLE address, the third device ID, and the third IRK of the third Bluetooth device. The dual-mode Bluetooth device may record the device information of a connected Bluetooth device, i.e., the Bluetooth device connected to the dual-mode Bluetooth device. In a case where the dual-mode device is connected to another dual-mode Bluetooth device, the dual-mode Bluetooth device may record the device information related to the classic Bluetooth and the device information related to the BLE.

Based on FIGS. 1 and 2 and the description mentioned above, the response strategy may include the following: in a case where the determination module 920 determine that the third Bluetooth device and the second Bluetooth device are the same device, the determination module 920 may respond to the BLE connection request from the third Bluetooth device to establish the connection relationship shown in FIG. 2 with the second Bluetooth device; and in a case where the determination module 920 determine that the third Bluetooth device and the second Bluetooth device are not the same device, the determination module 920 may not respond to or may reject the BLE connection request from the third Bluetooth device, otherwise the connection relationship shown in FIG. 1 will be established.

In some embodiments, in a case where the determination module 920 determines that the second Bluetooth device and the third Bluetooth device are the same device, the performing module 930 may respond to the BLE connection request and establish the BLE connection with the third Bluetooth device. Correspondingly, in a case where the determination module 920 determines that the second Bluetooth device and the third Bluetooth device are not the same device, the performing module 930 may reject the BLE connection request.

In some embodiments of the present disclosure, the first Bluetooth device first establishes the classic Bluetooth connection with the second Bluetooth device. When the third Bluetooth device that sends the BLE connection request to the first Bluetooth device is the same as the second Bluetooth device, the first Bluetooth device may respond to the BLE connection request and establish the BLE connection with the third Bluetooth device (i.e., the second Bluetooth device), ensuring that the first Bluetooth device and the second Bluetooth device may establish both the classic Bluetooth connection and the BLE connection, reducing the uncertainty of the dual-mode connection between dual-mode Bluetooth devices, and improving the user experience.

In some embodiments, the connection apparatus may include a configuration module. Since the first Bluetooth device is required to be initially paired with a new device, the configuration module first configures the first Bluetooth device in the pairing state. The initial pairing refers to the initial or first connection between the first Bluetooth device and another dual-mode Bluetooth device when no classic Bluetooth connection or BLE connection has been established between the first Bluetooth device and the another dual-mode Bluetooth device. After the initial pairing, both the first Bluetooth device and the another dual-mode Bluetooth device may record each other's device information (such as identity information). In some embodiments, the pairing state means that the classic Bluetooth interface is in a discoverable and connectable state, and the BLE interface is in a state where the BLE broadcasting is prohibited or disabled. An external device can discover the classic Bluetooth interface of the first Bluetooth device, but cannot discover the BLE interface of the first Bluetooth device. Therefore, when the first Bluetooth device is in the pairing state, the BLE interface will not be connected to a Bluetooth device which has ever been connected to the first Bluetooth device, and only the classic Bluetooth interface is discoverable at this time.

In some embodiments, the connection apparatus 900 may further include a first enabling module. The first enabling module may be configured to enable the BLE broadcasting in a case where the classic Bluetooth connection is established between the first Bluetooth device and the second Bluetooth device.

In a case where the classic Bluetooth connection is established between the first Bluetooth device and the second Bluetooth device, the first enabling module may enable the BLE broadcasting and begin receiving the BLE connection request, and whether the Bluetooth device sending the BLE connection request is the second Bluetooth device may be identified under the circumstances.

In some embodiments, the first enabling module is configured to: in a case where the second Bluetooth device is determined as a dual-mode Bluetooth device, the first enabling module may enable the BLE broadcast in a case where the classic Bluetooth connection is established between the first Bluetooth device and the second Bluetooth device. There is a case where the first Bluetooth device is a dual-mode Bluetooth device, and the second Bluetooth device is a single-mode Bluetooth device that only supports the classic Bluetooth connection. In this case, the first Bluetooth device does not need to use its BLE interface when paired with the second Bluetooth device. Even if the first Bluetooth device enables its BLE interface, the second Bluetooth device does not support the connection. Thus, the first Bluetooth device may be used as a single-mode Bluetooth device in this case. To reduce unnecessary power consumption, only in a case where it is determined that the second Bluetooth device is a dual-mode Bluetooth device, will the first enabling module be triggered to enable the BLE broadcasting in response to completing the establishment of the classic Bluetooth connection.

In some embodiments, the pairing state configured by the configuration module may only configure the classic Bluetooth interface of the first Bluetooth device in a discoverable and connectable state, while the BLE module of the first Bluetooth device is configured to send the second BLE broadcast. The second BLE broadcast is configured to indicate a Bluetooth device that scans and finds the second BLE broadcast to display device discovery information.

In some embodiments, the second BLE broadcast is a directed broadcasting message. A target address of the directed broadcasting message may be configured as a specified value, and the specified value should avoid pointing to any device, for example, the specified value may be FF:FF:FF:FF:FF:FF. An external Bluetooth device, such as the second Bluetooth device, will not initiate establishment of a BLE connection with the first Bluetooth device after receiving the second BLE broadcast because the second BLE broadcast carries a target address that does not point to the second Bluetooth device. In addition, since the target address is the specified value, after identifying that the target address is the specified value, the second Bluetooth device may trigger the display of the device discovery information for the user.

In some embodiments, the connection apparatus 900 includes an adjustment module. The adjustment module may be configured to change the second BLE broadcast to the first BLE broadcast in a case where the classic Bluetooth connection is established between the first Bluetooth device and the second Bluetooth device.

After establishing the classic Bluetooth connection with the second Bluetooth device, the first Bluetooth device may only agree to establish a BLE connection in a case where a Bluetooth device that subsequently sends the BLE connection request is the second Bluetooth device. Therefore, the adjustment module may change the second BLE broadcast to the first BLE broadcast. The first BLE broadcast is configured to indicate that the first Bluetooth device is capable of responding to the BLE connection request. After receiving the first BLE broadcast, the second Bluetooth device may send the BLE connection request to the first Bluetooth device.

In some embodiments, in case that the second Bluetooth device is a single-mode Bluetooth device that only supports a classic Bluetooth, the first Bluetooth device does not need to enable the BLE broadcasting. In this case, the first Bluetooth device and the second Bluetooth device may only establish the classic Bluetooth connection, and there is no need to continue subsequent operations However, the adjustment module is configured to: in a case where it is determined that the second Bluetooth device is a dual-mode Bluetooth device, change the second BLE broadcast to the first BLE broadcast in a case where the classic Bluetooth connection is established between the first Bluetooth device and the second Bluetooth device.

In this embodiment, when receiving the classic Bluetooth connection request sent by the second Bluetooth device, the first Bluetooth device establishes the classic Bluetooth connection with the second Bluetooth device.

In some embodiments, the determination module 920 may include an obtaining sub-module. The obtaining sub-module may be configured to obtain the second IRK of the second Bluetooth device based on the SMP between first Bluetooth device and the second Bluetooth device. The determination module may include a calculation sub-module. The calculation sub-module may be configured to calculate the second BLE address of the second Bluetooth device based on the second IRK.

In some embodiments, the connection apparatus 900 may include a third obtaining module. The third obtaining module may be configured to obtain the third BLE address of the third Bluetooth device based on the BLE connection request sent by the third Bluetooth device.

In some embodiments, the BLE connection request sent by the third Bluetooth device y may directly carry the third BLE address of the third Bluetooth device, and the third obtaining module may directly obtain the third BLE address and compare the third BLE address with the second BLE address calculated by the calculation submodule.

In some embodiments of the present disclosure, when the first Bluetooth device is in the pairing state, the first Bluetooth device may first establish the classic Bluetooth connection with the second Bluetooth device. In a case where the third Bluetooth device sending the BLE connection request to the first Bluetooth device is the same as the second Bluetooth device, the first Bluetooth device may respond to the BLE connection request and establish the BLE connection with the third Bluetooth device (i.e., the second Bluetooth device), ensuring that the first Bluetooth device and the second Bluetooth device may establish both the classic Bluetooth connection and the BLE connection, reducing the occurrence that the BLE interface is preemptively connected with a previously connected Bluetooth device in a case where a dual-mode Bluetooth device is required to be initially paired with another dual-mode Bluetooth device, thereby reducing the inability of completing the re-pairing of the dual-mode Bluetooth device with the another dual-mode Bluetooth device, and improving the user experience.

As shown in FIG. 10, in some embodiments, a device connection apparatus 1000 may be provided. The device connection apparatus 1000 may be configured in a third Bluetooth device. The third Bluetooth device may be a dual-mode Bluetooth device. The device connection apparatus 1000 of the third Bluetooth device may include a sending module 1010 and a connection module 1020.

The sending module 1010 is configured to send a BLE connection request to a first Bluetooth device when a classic Bluetooth connection is established between the third Bluetooth device and the first Bluetooth device.

The connection module 1020 is configured to establish a BLE connection with the first Bluetooth device in a case where the first Bluetooth device determines that the third Bluetooth device and the second Bluetooth device are the same device.

The second Bluetooth device may be a Bluetooth device that has established a classic Bluetooth connection with the first Bluetooth device.

In some embodiments, the first Bluetooth device and the third Bluetooth device may be dual-mode Bluetooth devices. In a case where the user operates the third Bluetooth device to establish the classic Bluetooth connection with the first Bluetooth device, the third Bluetooth device is required to continue to establish the BLE connection with the first Bluetooth device, only in this way can the dual-mode connection between the third Bluetooth device and the first Bluetooth device be completed.

In some embodiments, the sending module 1010 may send the BLE connection request to the first Bluetooth device only in a case where the third Bluetooth device scans and finds a BLE broadcast that matches the first Bluetooth device.

In some embodiments, the connection apparatus 1000 may further include a fourth obtaining module. The fourth obtaining module may be configured to obtain the first device information of the first Bluetooth device based on the classic Bluetooth connection between the third Bluetooth device and the first Bluetooth device, and obtain the fourth device information based on the scanned BLE broadcast. The fourth device information is device information of the fourth Bluetooth device that sends the BLE broadcast. The connection apparatus 1000 may further include a second determination module. The second determination module may be configured to determine that the scanned BLE broadcast matches the first Bluetooth device in a case where it is determined that the first device information matches the fourth device information.

In some embodiments, the first device information may include at least one of: a first classic BT address, a first BLE address, a first device ID, and a first IRK of the first Bluetooth device. In some embodiments, the fourth device information may include at least one of: a fourth classic BT address, a fourth BLE address, a fourth device ID, and a fourth IRK of the fourth Bluetooth device.

In a case where the first Bluetooth device determines that the third Bluetooth device and the second Bluetooth device are the same device, the connection module may establish a BLE connection with the first Bluetooth device.

The second Bluetooth device is a Bluetooth device that has established the classic Bluetooth connection with the first Bluetooth device. That is, in a case where the classic Bluetooth connection is established between the third Bluetooth device and the first Bluetooth device, when the third Bluetooth device sends the BLE connection request to the first Bluetooth device, the first Bluetooth device may determine whether the third Bluetooth device that initiates establishment of the BLE connection is the same as the second Bluetooth device that has currently established the classic Bluetooth connection with the first Bluetooth device. In a case where the third Bluetooth device is the same as the second Bluetooth device, the first Bluetooth device may respond to the BLE connection request and establish the BLE connection with the third Bluetooth device, thereby the achieving dual-mode pairing between the first Bluetooth device and the third Bluetooth device.

In some embodiments of the present disclosure, the first Bluetooth device may first establish the classic Bluetooth connection with the second Bluetooth device. In a case where the third Bluetooth device sends the BLE connection request to the first Bluetooth device and the first Bluetooth device determines that the third Bluetooth device is the same as the second Bluetooth device, the first Bluetooth device may respond to the BLE connection request and establish a BLE connection with the third Bluetooth device (i.e., the second Bluetooth device), ensuring that the first Bluetooth device and the second Bluetooth device may establish both the classic Bluetooth connection and the BLE connection therebetween, reducing the uncertainty of the dual-mode connection between the dual-mode Bluetooth devices, and improving the user experience.

In some embodiments, the connection apparatus 1000 may further include a request module. The request module may be configured to send a classic Bluetooth connection request to the first Bluetooth device in a case where the classic Bluetooth interface of the first Bluetooth device is in the discoverable and connectable state.

In a case where the first Bluetooth device is required to be initially paired with a new device, the first Bluetooth device is configured in a pairing state. The initial pairing refers to the initial or first connection between the first Bluetooth device and another dual-mode Bluetooth device in a case where no classic Bluetooth connection or BLE connection has been ever established between the first Bluetooth device and the another Bluetooth device. After the initial pairing, both the first Bluetooth device and the another Bluetooth device may record each other's device information (such as identity information). In some embodiments, the pairing state means that the classic Bluetooth interface is in the discoverable and connectable state and the BLE interface is in a state where the BLE broadcasting is prohibited or disabled.

In some embodiments, the connection apparatus 1000 may further include a display module. The first Bluetooth device may not prohibit or disable the BLE broadcasting in the pairing state but send the second BLE broadcast. The display module may be configured to display the device discovery information in response to receiving the second BLE broadcast sent by the first Bluetooth device. The second BLE broadcast is configured to indicate a Bluetooth device which has scanned and found the second BLE broadcast to display the device discovery information. After the classic Bluetooth connection is established between the first Bluetooth device and a certain Bluetooth device, the first Bluetooth device may change the second BLE broadcast to the first BLE broadcast. The first BLE broadcast is configured to indicate the Bluetooth device which has scanned and found the first BLE broadcast that, the first Bluetooth device is capable of responding to the BLE connection request.

In some embodiments, the second BLE broadcast may be the directed broadcasting message, and a target address of the directed broadcasting message may be configured as a specified value, for example, the specified value may be FF:FF:FF:FF:FF:FF. The display module may identify the specified value and trigger the display of device discovery information.

In some embodiments, the third Bluetooth device may establish the classic Bluetooth connection with the first Bluetooth device. The first Bluetooth device and the third Bluetooth device may be dual-mode Bluetooth devices.

In this embodiment, the third Bluetooth device is a device that is required to be initially paired with the first Bluetooth device. After scanning and finding the classic Bluetooth interface of the first Bluetooth device, the third Bluetooth device may initiate the establishment of the classic Bluetooth connection between the connection module 1020 and the first Bluetooth device via user triggering, that is, the sending module 1010 may send the classic Bluetooth connection request to the first Bluetooth device.

In some embodiments, the connection apparatus 1000 may further include a second enabling module. The second enabling module may be configured to enable the BLE scanning in a case where the third Bluetooth device establishes the classic Bluetooth connection with the first Bluetooth device. In some embodiments, the third Bluetooth device may prohibit the BLE scanning before the classic Bluetooth connection is established between the third Bluetooth device and the first Bluetooth device. Since the BLE connection is needed only after the classic Bluetooth connection is established, this process arrangement may save power consumption of the third Bluetooth device.

In some embodiments, the second enabling module may enable the BLE scanning in a case where the third Bluetooth device establishes the classic Bluetooth connection with the first Bluetooth device and identifies that the first Bluetooth device is a dual-mode Bluetooth device. That is, in a case where the first Bluetooth device is not a dual-mode Bluetooth device, even if the classic Bluetooth connection is established between the third Bluetooth device and the first Bluetooth device, there is no need for the third Bluetooth device to enable the BLE scanning. This process arrangement may further save the power consumption of the third Bluetooth device.

In some embodiments, the connection apparatus 1000 may further include a second obtaining sub-module. The second obtaining sub-module may be configured to obtain the first IRK of the first Bluetooth device based on the SMP between the third Bluetooth device and the first Bluetooth device.

During the process of establishing the classic Bluetooth connection between the first Bluetooth device and the third Bluetooth device, both the first Bluetooth device and the third Bluetooth device are required to exchange security information based on the SMP.

In some embodiments, the connection apparatus 1000 may further include a second calculation module. The second calculation module may be configured to calculate the first BLE address of the first Bluetooth device based on the first IRK. The first BLE address of the first Bluetooth device may be calculated based on the IRK calculation rule.

In some embodiments, the third Bluetooth device may write the device information of the first Bluetooth device into the white list.

In a case where the third Bluetooth device scans and finds the BLE broadcast that matches the first Bluetooth device, the sending module 1010 may send the BLE connection request to the first Bluetooth device. In the BLE connection request, the third IRK or the third BLE address of the third Bluetooth device may be carried.

In a case where the first Bluetooth device determines that the third Bluetooth device and the second Bluetooth device are the same device, the connection module 1020 may establish the BLE connection with the first Bluetooth device.

The second Bluetooth device is a Bluetooth device that has established the classic Bluetooth connection with the first Bluetooth device. In this embodiment, for the first Bluetooth device, it is necessary to first assume that the first Bluetooth device has established the classic Bluetooth connection with the second Bluetooth device, since the BLE broadcasting is enabled, the received BLE connection request may come from a Bluetooth device other than the second Bluetooth device. Therefore, the device that first establishes the classic Bluetooth connection with the first Bluetooth device is called the second Bluetooth device. In fact, in this embodiment, the second Bluetooth device is the third Bluetooth device.

When the second BLE address of the second Bluetooth device matches the third BLE address of the third Bluetooth device, the first Bluetooth device may determine that the second Bluetooth device and the third Bluetooth device are the same device. Based on the determination that the second Bluetooth device and the third Bluetooth device are the same device, the first Bluetooth device may establish the BLE connection with the third Bluetooth device in response to the BLE connection request. In this way, the first Bluetooth device and the third Bluetooth device may establish the connection relationship shown in FIG. 2.

In some embodiments of the present disclosure, when the first Bluetooth device is in the pairing state (the pairing state described here initially prohibits the enabling of the BLE broadcasting, which may be called a first pairing state), the first Bluetooth device may first establish the classic Bluetooth connection with the second Bluetooth device. In a case where the third Bluetooth device sending the BLE connection request to the first Bluetooth device is the same as the second Bluetooth device, the first Bluetooth device may respond to the BLE connection request and establish the BLE connection with the third Bluetooth device (i.e., the second Bluetooth device), ensuring that the first Bluetooth device and the second Bluetooth device may establish both the classic Bluetooth connection and the BLE connection, reducing the occurrence that the BLE interface is preemptively connected with a previously connected Bluetooth device in a case where a dual-mode Bluetooth device is required to be initially paired with another dual-mode Bluetooth device, thereby reducing the inability of completing the re-pairing of the dual-mode Bluetooth device with the another dual-mode Bluetooth device, and improving the user experience.

FIG. 11 is a structural block diagram of a Bluetooth device according to some embodiments of the present disclosure. As shown in FIG. 11, a Bluetooth device 1100 may include one or more of the following components: a processor 1110, a memory 1120 coupled to the processor 1110. The memory 1120 may store one or more computer programs, and the one or more computer programs may be configured to be executed by one or more processors 1110 to implement the methods described in the above embodiments.

The processor 1110 may include one or more processing cores. The processor 1110 may connect various parts of the entire Bluetooth device 1100 through various interfaces and circuits, and execute various functions and process data of the Bluetooth device 1100 by running or executing instructions, programs, code sets, or instruction sets stored in the memory 1120, and by invoking data stored in the memory 1120. In some embodiments, the processor 1110 may be implemented in least one hardware form including: a Digital Signal Processing (DSP), a Field-Programmable Gate Array (FPGA), or a Programmable Logic Array (PLA). The processor 1110 may integrate one or more of a Central Processing Unit (CPU), a Graphics Processing Unit (GPU), and a modem. The CPU mainly processes an operating system, a user interface, and an application. The GPU is responsible for rendering and drawing display content. The modem is responsible for processing wireless communication. It may be understood that the above modem may not be integrated into the processor 1110 but implemented separately through a communication chip.

The memory 1120 may include a Random Access Memory (RAM) and a Read-Only Memory (ROM). The memory 1120 may be configured to store instructions, programs, code, code sets, or instruction sets. The memory 1120 may include a program storage area and a data storage area. The program storage area may store instructions for implementing the operating system, instructions for implementing at least one function (such as a touch function, a sound playback function, and image playback function, etc.), and instructions for implementing the above method embodiments. The data storage area may store data created during the use of the Bluetooth device 1100.

The Bluetooth device 1100 may include a Bluetooth module, and the Bluetooth module may be configured to provide a Bluetooth communication function to establish Bluetooth a connection with other electronic devices and perform Bluetooth data transmission. The Bluetooth module may support one or more Bluetooth protocols, such as a classic Bluetooth, BLE, etc., which is not limited and may change with the development of Bluetooth protocols.

In some embodiments, the Bluetooth device 1100 may be an earphone device. The earphone device may include a first earphone, a second earphone, and an earphone case. The first earphone and the second earphone may each include at least the above processor 1110, the memory 1120, and the Bluetooth module.

It may be understood that the Bluetooth device 1100 may include more or fewer structural components than those shown in the above structural block diagram, such as a power module, a physical button, and a sensor, etc., which are not limited here.

Some embodiments of the present disclosure provide a device connection method performed by a first Bluetooth device. The method includes: receiving a Bluetooth low energy (BLE) connection request sent by a third Bluetooth device in a case where a classic Bluetooth connection is established between the first Bluetooth device and a second Bluetooth device; determining whether the second Bluetooth device and the third Bluetooth device are the same device; and performing a response strategy for the BLE connection request based on a determination result.

In some embodiments, the determining whether the second Bluetooth device is the same as the third Bluetooth device includes: determining that the second Bluetooth device and the third Bluetooth device are the same device in a case where second device information of the second Bluetooth device matches third device information of the third Bluetooth device; and determining that the second Bluetooth device and the third Bluetooth device are different devices in a case where the second device information of the second Bluetooth device does not match the third dev ice information of the third Bluetooth device.

In some embodiments, the second device information includes at least one of a second classic Bluetooth (BT) address of the second Bluetooth device, a second BLE address of the second Bluetooth device, a second device identity (ID) of the second Bluetooth device, and a second identity resolving key (IRK) of the second Bluetooth device; and the third device information includes at least one of a third classic BT address of the third Bluetooth device, a third BLE address of the third Bluetooth device, a third device ID of the third Bluetooth device, and a third IRK of the third Bluetooth device.

In some embodiments, the method further includes: obtaining the second device information based on the classic Bluetooth connection between the first Bluetooth device and the second Bluetooth device.

In some embodiments, the second device information includes a second BLE address of the second Bluetooth device; and the obtaining the second device information based on the classic Bluetooth connection between the first Bluetooth device and the second Bluetooth device includes: obtaining a second identity resolving key (IRK) of the second Bluetooth device based on a security manage protocol (SMP) between the first Bluetooth device and the second Bluetooth device; and obtaining the second BLE address based on the second IRK.

In some embodiments, the method further includes: obtaining the third device information based on the BLE connection request sent by the third Bluetooth device.

In some embodiments, the third device information includes a third BLE address of the third Bluetooth device.

In some embodiments, before the receiving a BLE connection request sent by a third Bluetooth device, the method further includes: configuring a classic Bluetooth interface of the first Bluetooth device in a discoverable and connectable state; and establishing the classic Bluetooth connection with the second Bluetooth device in response to receiving a classic Bluetooth connection request sent by the second Bluetooth device.

In some embodiments, the method further includes: configuring the first Bluetooth device in a state where BLE broadcasting is prohibited; enabling the BLE broadcasting in response to establishing the classic Bluetooth connection with the second Bluetooth device; or in a case where second Bluetooth device is a dual-mode Bluetooth device, enabling the BLE broadcasting in response to establishing the classic Bluetooth connection with the second Bluetooth device.

In some embodiments, the method further includes: sending a second BLE broadcast, the second BLE broadcast being configured to indicate a Bluetooth device that scans the second BLE broadcast to display device discovery information; and changing the second BLE broadcast to a first BLE broadcast in response to the first Bluetooth device establishing the classic Bluetooth connection with the second Bluetooth device; or in a case where the second Bluetooth device is the dual-mode Bluetooth device, changing the second BLE broadcast to the first BLE broadcast in response to the first Bluetooth device establishing the classic Bluetooth connection with the second Bluetooth device; the first BLE broadcast is configured to indicate that the first Bluetooth device is capable of responding to the BLE connection request.

In some embodiments, the second BLE broadcast is a directed broadcasting message, and a target address of the directed broadcasting message is configured as a specified value.

In some embodiments, the performing a response strategy for the BLE connection request based on a determination result includes: responding to the BLE connection request and establishing a BLE connection with the third Bluetooth device in a case where the second Bluetooth device and the third Bluetooth device are the same device; and rejecting the BLE connection request in a case where the second Bluetooth device and the third Bluetooth device are different devices.

Some embodiments of the present disclosure provide a device connection method performed by a third Bluetooth device. The method includes: sending a Bluetooth low energy (BLE) connection request to a first Bluetooth device in a case where a classic Bluetooth connection is established between the third Bluetooth device and the first Bluetooth device; and establishing a BLE connection with the first Bluetooth device in a case where the first Bluetooth device determines that the third Bluetooth device and a second Bluetooth device are the same device. The second Bluetooth device is a Bluetooth device that has established a classic Bluetooth connection with the first Bluetooth device.

In some embodiments, the sending a BLE connection request to a first Bluetooth device includes: sending the BLE connection request to the first Bluetooth device in a case where the third Bluetooth device scans a BLE broadcast that matches the first Bluetooth device.

In some embodiments, the method further includes: obtaining first device information of the first Bluetooth device based on the classic Bluetooth connection between the third Bluetooth device and the first Bluetooth device; obtaining fourth device information based on the scanned BLE broadcast, the fourth device information being device information of a fourth Bluetooth device that sends the scanned BLE broadcast; and determining that the scanned BLE broadcast matches the first Bluetooth device in a case where the first device information matches the fourth device information.

In some embodiments, the first device information includes at least one of a first classic Bluetooth (BT) address of the first Bluetooth device, a first BLE address of the first Bluetooth device, a first device identity (ID) of the first Bluetooth device, and the first identity resolving key (IRK) of the first Bluetooth device; and the fourth device information includes at least one of a fourth classic BT address of the fourth Bluetooth device, a fourth BLE address of the fourth Bluetooth device, a fourth device ID of the fourth Bluetooth device, and a fourth IRK of the fourth Bluetooth device.

In some embodiments, the first device information includes a first BLE address of the first Bluetooth device; the obtaining first device information of the first Bluetooth device based on the classic Bluetooth connection between the third Bluetooth device and the first Bluetooth device includes: obtaining a first identity resolving key (IRK) of the first Bluetooth device based on a security manage protocol (SMP) between the third Bluetooth device and the first Bluetooth device; and obtaining the first BLE address based on the first IRK.

In some embodiments, the method further includes: sending a classic Bluetooth connection request to the first Bluetooth device in a case where a classic Bluetooth interface of the first Bluetooth device is in a discoverable and connectable state; and establishing the classic Bluetooth connection with the first Bluetooth device.

In some embodiments, before the sending a BLE connection request to a first Bluetooth device, the method further includes: enabling a BLE scanning in a case where the third Bluetooth device establishes the classic Bluetooth connection with the first Bluetooth device; or enabling the BLE scanning in a case where the third Bluetooth device establishes the classic Bluetooth connection with the first Bluetooth device and identifies that the first Bluetooth device is a dual-mode Bluetooth device.

In some embodiments, the method further includes: displaying device discovery information in response to receiving a second BLE broadcast sent by the first Bluetooth device, the second BLE broadcast being configured to indicate a Bluetooth device that scans the second BLE broadcast to display the device discovery information.

In some embodiments, the second BLE broadcast is a directed broadcasting message, and a target address of the directed broadcasting message is configured as a specified value.

Some embodiments of the present disclosure provide device connection apparatus configured in a first Bluetooth device. The device connection apparatus includes a receiving module, configured to receive a Bluetooth low energy (BLE) connection request sent by a third Bluetooth device in a case where a classic Bluetooth connection is established between the first Bluetooth device and a second Bluetooth device; a determination module, configured to determine whether the second Bluetooth device and the third Bluetooth device are the same device; and a performing module, configured to perform a response strategy for the BLE connection request based on a determination result.

Some embodiments of the present disclosure provide device connection apparatus configured in a third Bluetooth device. The device connection apparatus includes a sending module, configured to send a Bluetooth low energy (BLE) connection request to a first Bluetooth device in a case where a classic Bluetooth connection is established between the third Bluetooth device and the first Bluetooth device; and a connection module, configured to establish a BLE connection with the first Bluetooth device in a case where the first Bluetooth device determines that the third Bluetooth device and a second Bluetooth device are the same device. The second Bluetooth device is a Bluetooth device that has established a classic Bluetooth connection with the first Bluetooth device.

Some embodiments of the present disclosure provide a Bluetooth device including a memory and a processor. The memory stores a computer program that, when executed by the processor, enables the processor to implement any one of the above methods.

Some embodiments of the present disclosure provide a computer-readable storage medium storing a computer program. The computer program, when executed by a processor, implements the methods described in the above embodiments.

Some embodiments of the present disclosure provide a computer program product. The computer program product includes a non-transitory computer-readable storage medium storing a computer program, and the computer program, when executed by a processor, implements the methods described in the above embodiments.

Those skilled in the art may understand that all or some of the processes in the above method embodiments may be implemented by instructing a relevant hardware through a computer program. The program may be stored in a non-transitory computer-readable storage medium, and when executed, the program may include the processes of the above method embodiments. The storage medium may be a magnetic disk, an optical disk, or a ROM, etc.

Any reference to memory, storage, database, or other media herein may include non-transitory and/or transitory memory. A suitable non-transitory memory may include a ROM, a Programmable ROM (PROM), an Erasable PROM (EPROM), an Electrically Erasable PROM (EEPROM), or a flash memory. A transitory memory may include a Random Access Memory (RAM), which serves as an external cache memory. By way of illustration and not limitation, the RAM may be in various forms, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), a Rambus DRAM (RDRAM), and a Direct Rambus DRAM (DRDRAM).

The above describes in detail the device connection method, the device connection apparatus, the Bluetooth device, and the storage medium disclosed in some embodiments of the present disclosure. Some examples are used in the present disclosure to explain the principles and implementation of the present disclosure. The descriptions of the above embodiments are only used to help understand the methods and core ideas of the present disclosure. In addition, those skilled in the art may change the implementation and application scope based on the ideas of the present disclosure. In summary, the content of this specification should not be construed as limitation of the present disclosure.

1. A device connection method, performed by a first Bluetooth device, and comprising:
receiving a Bluetooth low energy (BLE) connection request sent by a third Bluetooth device in a case where a classic Bluetooth connection is established between the first Bluetooth device and a second Bluetooth device;
responding to the BLE connection request and establishing a BLE connection with the third Bluetooth device in a case where the second Bluetooth device and the third Bluetooth device are the same device; and
rejecting the BLE connection request in a case where the second Bluetooth device and the third Bluetooth device are different devices.

2. The method as claimed in claim 1, wherein
the second Bluetooth device and the third Bluetooth device are the same device in a case where second device information of the second Bluetooth device matches third device information of the third Bluetooth device; and
the second Bluetooth device and the third Bluetooth device are different devices in a case where the second device information of the second Bluetooth device does not match the third device information of the third Bluetooth device.

3. The method as claimed in claim 2, wherein
the second device information comprises at least one of a second classic Bluetooth (BT) address of the second Bluetooth device, a second BLE address of the second Bluetooth device, a second device identity (ID) of the second Bluetooth device, and a second identity resolving key (IRK) of the second Bluetooth device; and
the third device information comprises at least one of a third classic BT address of the third Bluetooth device, a third BLE address of the third Bluetooth device, a third device ID of the third Bluetooth device, and a third IRK of the third Bluetooth device.

4. The method as claimed in claim 2, further comprising:
obtaining the second device information based on the classic Bluetooth connection between the first Bluetooth device and the second Bluetooth device;
wherein the second device information comprises a second BLE address of the second Bluetooth device; and
the obtaining the second device information based on the classic Bluetooth connection between the first Bluetooth device and the second Bluetooth device comprises:
obtaining a second identity resolving key (IRK) of the second Bluetooth device based on a security manage protocol (SMP) between the first Bluetooth device and the second Bluetooth device; and
obtaining the second BLE address based on the second IRK.

5. The method as claimed in claim 2, further comprising:
obtaining the third device information based on the BLE connection request sent by the third Bluetooth device.

6. The method as claimed in claim 5, wherein the third device information comprises a third BLE address of the third Bluetooth device.

7. The method as claimed in claim 1, before the receiving a BLE connection request sent by a third Bluetooth device, further comprising:
configuring a classic Bluetooth interface of the first Bluetooth device in a discoverable and connectable state; and
establishing the classic Bluetooth connection with the second Bluetooth device in response to receiving a classic Bluetooth connection request sent by the second Bluetooth device.

8. The method as claimed in claim 7, further comprising:
configuring the first Bluetooth device in a state where BLE broadcasting is prohibited;
enabling the BLE broadcasting in response to establishing the classic Bluetooth connection with the second Bluetooth device; or
in a case where second Bluetooth device is a dual-mode Bluetooth device, enabling the BLE broadcasting in response to establishing the classic Bluetooth connection with the second Bluetooth device.

9. The method as claimed in claim 7, further comprising:
sending a second BLE broadcast, the second BLE broadcast being configured to indicate a Bluetooth device that scans the second BLE broadcast to display device discovery information; and
changing the second BLE broadcast to a first BLE broadcast in response to the first Bluetooth device establishing the classic Bluetooth connection with the second Bluetooth device; or
in a case where the second Bluetooth device is the dual-mode Bluetooth device, changing the second BLE broadcast to the first BLE broadcast in response to the first Bluetooth device establishing the classic Bluetooth connection with the second Bluetooth device;
wherein the first BLE broadcast is configured to indicate that the first Bluetooth device is capable of responding to the BLE connection request.

10. The method as claimed in claim 9, wherein the second BLE broadcast is a directed broadcasting message, and a target address of the directed broadcasting message is configured as a specified value.

11. A device connection method, performed by a third Bluetooth device, and comprising:
sending a Bluetooth low energy (BLE) connection request to a first Bluetooth device in a case where a classic Bluetooth connection is established between the third Bluetooth device and the first Bluetooth device; and
establishing a BLE connection with the first Bluetooth device.

12. The method as claimed in claim 11, wherein the sending a BLE connection request to a first Bluetooth device comprises:
sending the BLE connection request to the first Bluetooth device in a case where the third Bluetooth device scans a BLE broadcast that matches the first Bluetooth device.

13. The method as claimed in claim 12, further comprising:
obtaining first device information of the first Bluetooth device based on the classic Bluetooth connection between the third Bluetooth device and the first Bluetooth device;
obtaining fourth device information based on the scanned BLE broadcast, the fourth device information being device information of a fourth Bluetooth device that sends the scanned BLE broadcast; and
determining that the scanned BLE broadcast matches the first Bluetooth device in a case where the first device information matches the fourth device information.

14. The method as claimed in claim 13, wherein
the first device information comprises at least one of a first classic Bluetooth (BT) address of the first Bluetooth device, a first BLE address of the first Bluetooth device, a first device identity (ID) of the first Bluetooth device, and the first identity resolving key (IRK) of the first Bluetooth device; and
the fourth device information comprises at least one of a fourth classic BT address of the fourth Bluetooth device, a fourth BLE address of the fourth Bluetooth device, a fourth device ID of the fourth Bluetooth device, and a fourth IRK of the fourth Bluetooth device.

15. The method as claimed in claim 13, wherein the first device information comprises a first BLE address of the first Bluetooth device;
wherein the obtaining first device information of the first Bluetooth device based on the classic Bluetooth connection between the third Bluetooth device and the first Bluetooth device comprises:
obtaining a first identity resolving key (IRK) of the first Bluetooth device based on a security manage protocol (SMP) between the third Bluetooth device and the first Bluetooth device; and
obtaining the first BLE address based on the first IRK.

16. The method as claimed in claim 11, further comprising:
sending a classic Bluetooth connection request to the first Bluetooth device in a case where a classic Bluetooth interface of the first Bluetooth device is in a discoverable and connectable state; and
establishing the classic Bluetooth connection with the first Bluetooth device.

17. The method as claimed in claim 16, before the sending a BLE connection request to a first Bluetooth device, the method further comprising:
enabling a BLE scanning in a case where the third Bluetooth device establishes the classic Bluetooth connection with the first Bluetooth device; or
enabling the BLE scanning in a case where the third Bluetooth device establishes the classic Bluetooth connection with the first Bluetooth device and identifies that the first Bluetooth device is a dual-mode Bluetooth device.

18. The method as claimed in claim 11, further comprising:
displaying device discovery information in response to receiving a second BLE broadcast sent by the first Bluetooth device, the second BLE broadcast being configured to indicate a Bluetooth device that scans the second BLE broadcast to display the device discovery information.

19. The method as claimed in claim 18, wherein the second BLE broadcast is a directed broadcasting message, and a target address of the directed broadcasting message is configured as a specified value.

20. A Bluetooth device, comprising a memory and a processor, wherein the memory stores a computer program that, when executed by the processor, enables the processor to implement a method, and the method comprises:
receiving a Bluetooth low energy (BLE) connection request sent by a third Bluetooth device in a case where a classic Bluetooth connection is established between the first Bluetooth device and a second Bluetooth device; responding to the BLE connection request and establishing a BLE connection with the third Bluetooth device in a case where the second Bluetooth device and the third Bluetooth device are the same device; and rejecting the BLE connection request in a case where the second Bluetooth device and the third Bluetooth device are different devices; or
sending a Bluetooth low energy (BLE) connection request to a first Bluetooth device in a case where a classic Bluetooth connection is established between the third Bluetooth device and the first Bluetooth device; and establishing a BLE connection with the first Bluetooth device.
